(19) United States
(12) Patent Application Publication
(10) Pub. No.: US 2016/0189121 A1
(43) Pub. Date: Jun. 30, 2016

(54) Method and System for Pushing Payment or Account Information to Multiple Retail and Payment Sites

(71) Applicants: John Best, Colorado Springs, CO (US); Edwin Gonzalez, Tampa, FL (US); Thomas Stacy, Highlands Ranch, CO (US); Elliot Cotto, Murfreesboro, TN (US)

(72) Inventors: John Best, Colorado Springs, CO (US); Edwin Gonzalez, Tampa, FL (US); Thomas Stacy, Highlands Ranch, CO (US); Elliot Cotto, Murfreesboro, TN (US)

(21) Appl. No.: 14/820,763

(22) Filed: Aug. 7, 2015

Related U.S. Application Data
(60) Provisional application No. 62/034,516, filed on Aug. 7, 2014.

(51) Int. Cl. G06Q 20/10; G06Q 20/24

(52) U.S. Cl. CPC G06Q 20/102; G06Q 20/24

(57) ABSTRACT

Novel tools and techniques are provided for implementing automatic updating or pushing of credit card data, other payment information, and/or personal data to multiple retail and payment sites (collectively, “vendor websites”). In some embodiments, a method might include providing a user interface to a user device associated with a user via an account management application running on the user device. The user interface might receive, from the user, a first set of inputs comprising instructions to push payment information and a second set of inputs comprising instructions indicating two or more user accounts for at least two vendor websites with which the payment information is to be updated. The account management application or a server computer subsequently automatically concurrently pushes the payment information to the two or more user accounts, in response to receiving the first and second sets of inputs from the user.

### CROSS-REFERENCES TO RELATED APPLICATIONS

This application claims priority to U.S. Patent Application Ser. No. 62/034,516 (the “'516 Application”), filed Aug. 7, 2014 by John Best et al. (attorney docket no. 0656.01PR), entitled, “Method and System for Pushing Credit Card Data to Multiple Retail and Payment Sites,” the entirely disclosure of which is incorporated herein by reference in its entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to a device, system, and method for handling payment or account information, and, more particularly, to a device, system, and method for automatically updating payment or account data and billing data to multiple retail and payment sites.

### BACKGROUND

Currently, when a user replaces a credit card (whether because the previous one has expired, because the old one has been compromised, or the like, and a new one has issued), when a user obtains a new credit card, when a user first establishes an account with an online vendor, or when the user's billing address has changed, the user has to manually enter his or her credit card information (and/or billing information) on the vendor's website. When the user has accounts with multiple vendors, and especially when the user has to update his or her credit card information (e.g., when the old card has either expired or been compromised, or the like), the process of updating the credit card information becomes tedious and time consuming, especially as different vendors tend to use different processes and systems for establishing user account systems and the like. Further, if there are many such accounts, the user might forget to update his or her information with particular accounts.

There are, at the time of filing of this application, no methods or systems known to the inventors that allows for automatic updating of credit card and billing information on multiple, oftentimes disparate retail and payment websites (collectively, “vendor websites”).

Hence, there is a need for more robust and scalable solutions for automatically updating credit card data (and more generally, automatically updating payment or account information) and billing data to multiple retail and payment sites.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a general schematic diagram illustrating a system for implementing automatic updating or pushing of payment information to multiple retail and payment sites, in accordance with various embodiments.

FIGS. 2A-2C are general schematic flow diagrams illustrating a method for implementing automatic updating or pushing of payment information to multiple retail and payment sites, in accordance with various embodiments.

FIGS. 3A-3H represent a system flow diagram illustrating a method for implementing automatic updating or pushing of payment information to multiple retail and payment sites, in accordance with various embodiments.

FIGS. 4A-4H represent a system flow diagram illustrating another method for implementing automatic updating or pushing of payment information to multiple retail and payment sites, in accordance with various embodiments.

FIGS. 5A-5C are general schematic flow diagrams illustrating another method for implementing automatic updating or pushing of payment information to multiple retail and payment sites, in accordance with various embodiments.

FIG. 6 is a block diagram illustrating an exemplary computer architecture, in accordance with various embodiments.

FIG. 7 is a block diagram illustrating a networked system of computers, which can be used in accordance with various embodiments.

### DETAILED DESCRIPTION OF CERTAIN EMBODIMENTS

### Overview

Various embodiments provide techniques for implementing automatic updating or pushing of payment information (which, herein, includes, without limitation, credit card data, other payment information, account information, billing information, and/or the like) to multiple retail and payment sites (collectively, “vendor websites”).

In some embodiments, a user may log into a master account (e.g., a single sign-on account, a card management account, a payment management account, and/or the like), and may be provided with access to tools or options to manage his or her payment accounts and information, to manage his or her vendor accounts, and/or the like within the account. For example, tools or options to manage the user's payment accounts and information might include, without limitation, tools or options to add a payment method (e.g., add a credit card, add a debit card, add a checking account, add a savings account, add a mortgage loan account, add another loan account, and/or the like), update information for the payment method (e.g., update expiration date, update card security code, setup a particular payment method as a default payment method, etc.), delete a payment method (e.g., delete a credit card, delete a debit card, delete a checking account, delete a savings account, delete a mortgage loan account, delete another loan account, and/or the like), update billing information (e.g., update user's name (if there has been a change of name), update user's billing address, update user's mailing address, update user's telephone number, update user's e-mail address, and/or the like), and/or the like.

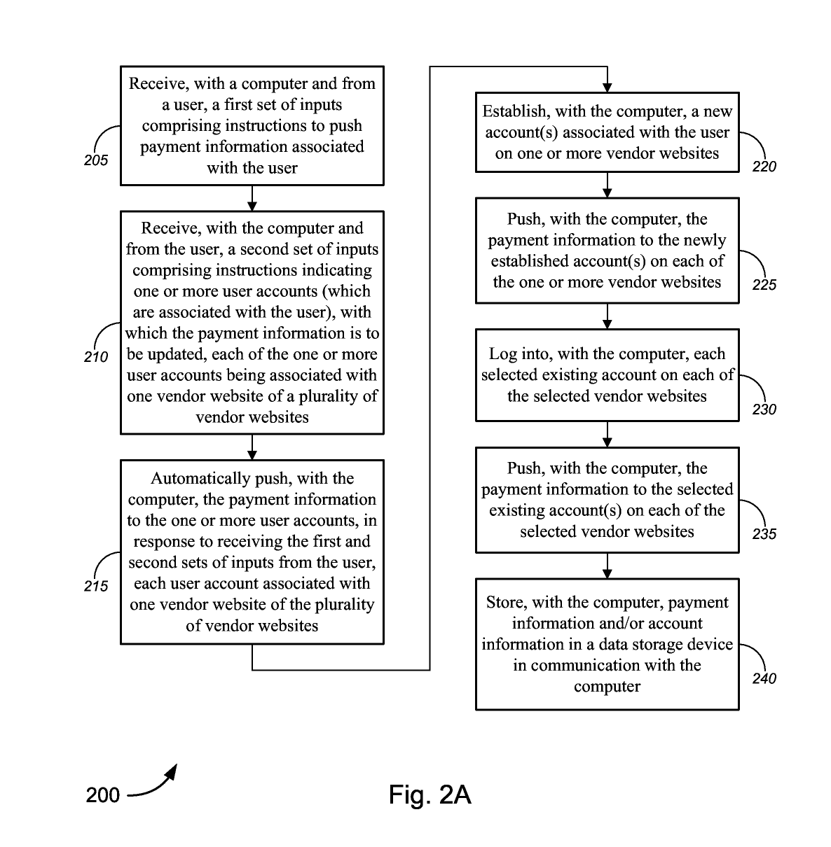

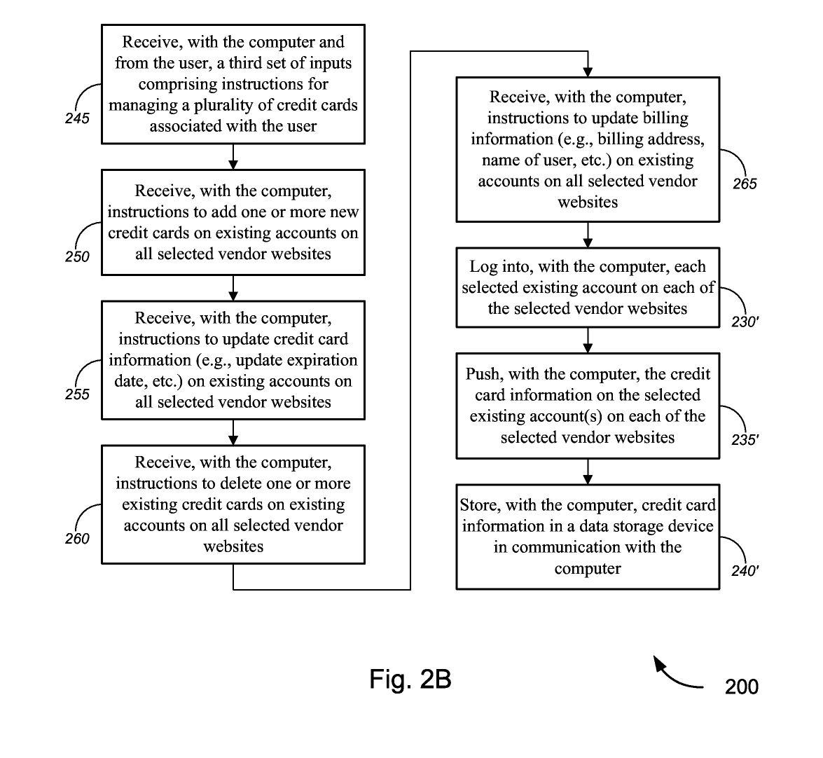

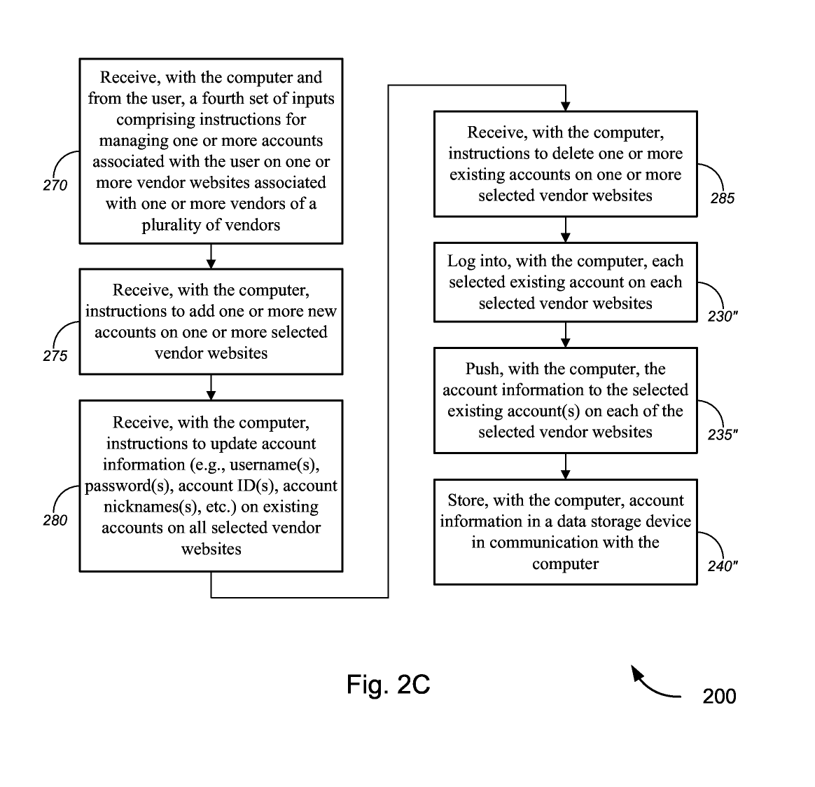

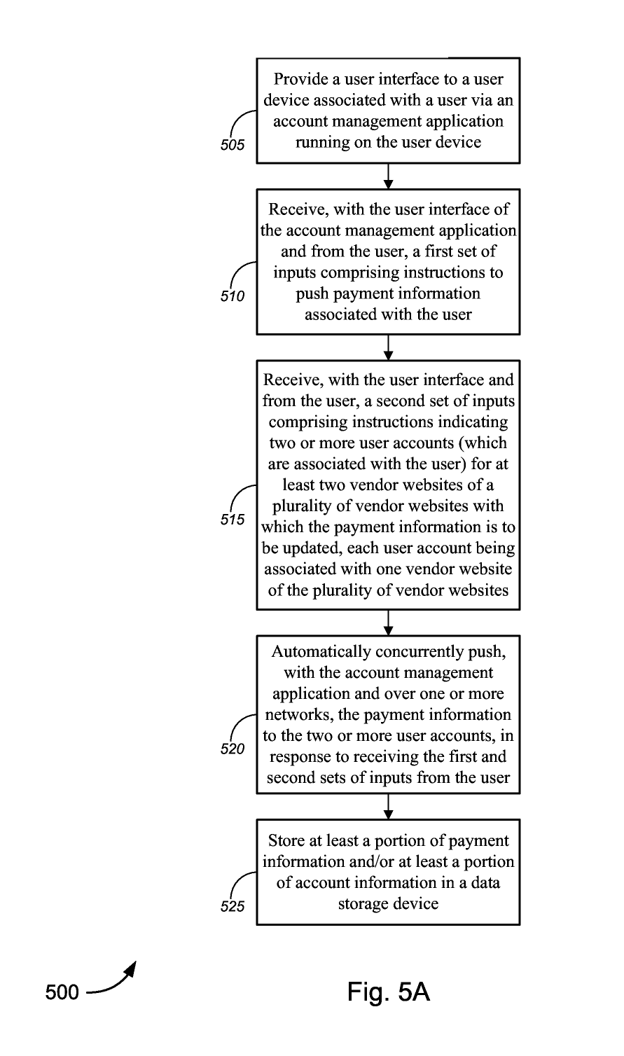

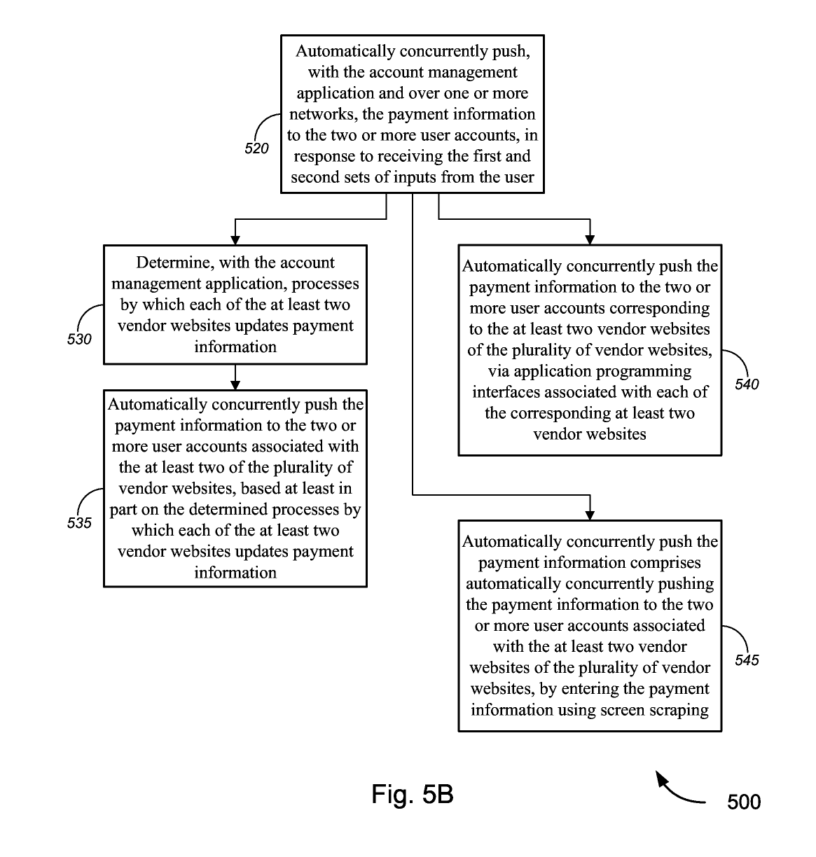

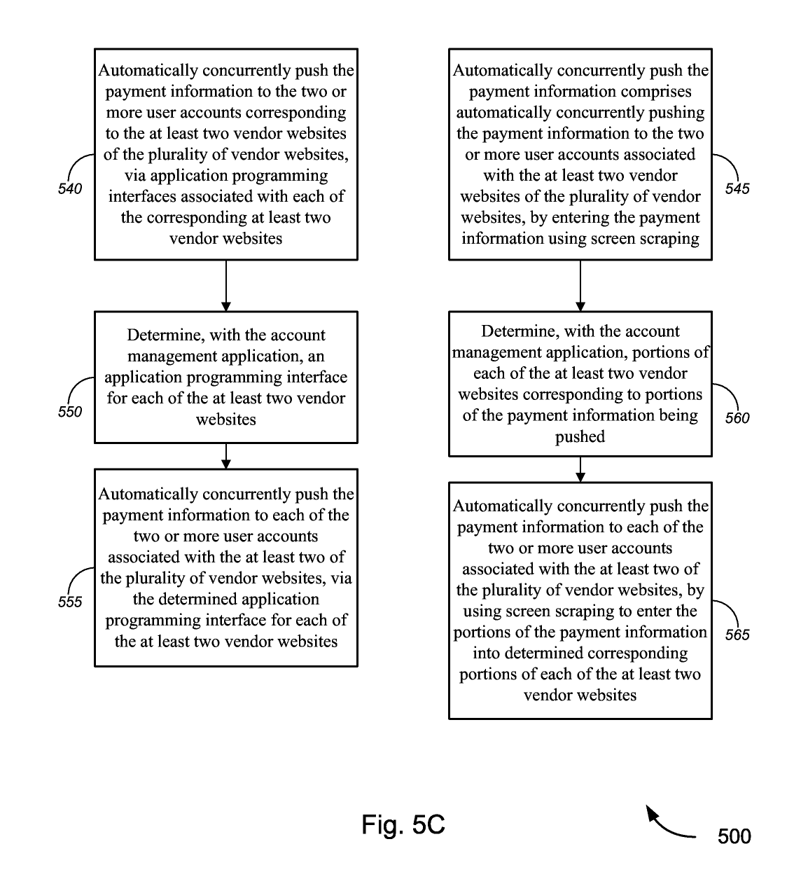

Herein, “vendor accounts” might refer to a user's accounts with a vendor, which might include a retailer, a utility company, a payment service, a bank, a trust company, a credit union, a loan company, and/or the like. In some cases, tools or options to manage the user's vendor accounts might include, without limitation, tools or options to set up user credentials for one or more vendors (which might be validated prior to storing on a database in communication with a system on which the master account is hosted by a card/payment management service provider), save the user credentials for one or more vendors, request adding new online vendors to a list of vendors (with which the card/payment management service provider maintains), add an account with a vendor, update vendor account information (e.g., update username, update password, update account identification (“ID”), update account nickname, and/or the like), delete an account with a vendor, and/or the like. Herein also, “automatic pushing” of payment information or other information (such as in the embodiment of at least FIG. 2) might refer to sequential, simultaneous, or (temporally) overlapped pushing of such information, while “automatic concurrent pushing” of payment information or other information (such as in the embodiment of at least FIG. 5) might refer to simultaneous or (temporally) overlapped pushing of such information. Here, “simultaneous” pushing of such information to multiple vendor websites or the like refers to the pushing of such information being initiated at the same time to the multiple vendor websites, while “overlapped” pushing of such information to multiple vendor websites or the like refers to non-sequential (i.e., parallel) pushing of such information to a first set of vendor websites being initiated at a first time, while pushing of such information to a second set of vendor websites is initiated at a second time different from the first time but before pushing of such information to the first set of vendor websites has ended.

The user may also be provided with tools or options to select which account(s) with which vendor(s) to update the user's payment accounts and information. Once the accounts and vendors have been selected, the system, on which the account is hosted, might push the payment accounts and information to the selected accounts and vendors (i.e., to push the information to multiple retail and/or payment sites). Vendors with application programming interfaces (“APIs”) that can be used to submit credit card information will facilitate pushing of payment accounts and information, while non-API vendors will require additional development to enter payment information via “screen-scraping” or the like.

In this manner, a user can easily update all relevant vendor accounts whenever the user changes a payment method (e.g., credit card), whenever a payment method expires and a new one issues (e.g., when a credit card expires and a new card is issued), whenever the user changes addresses, and/or the like, without having to personally log into each relevant vendor's website and change by hand the payment information for the individual vendor.

Because of the use of the master account to store the users' credentials for multiple vendors, the database and the website for the master account may include security features, including, but not limited to, the use of SQL databases to secure securely store all user information, appropriate network security measures, and/or the like. In some cases, a local administrative website might be used to manage user and vendor data. In some instances, a financial institution's administrative website might be used to manage corporate website configuration elements and to view reporting.

From the perspective of a financial institution, payment service, card/payment service provider, or the like (collectively, “service provider”), providing a user with these tools and options via a master user account might provide the service provider with a competitive advantage by making it easy for its customers to setup their credit cards in retailer and payment sites (such as Paypal®, Amazon.com®, eBay®, and/or the like.) Financial institutions and credit card providers, by licensing such technology, may incentivize their customers to use. Such technology might include software that pushes credit card data to multiple retail and payment sites by using a variety of methods to set the card as the default method of payment on that site. This can be done as a one to many transactional push. When financial institutions partner with the card/payment service provider, the financial institution's members might be directed to the service via the financial institution's website. The financial institution, in some cases, might pay both monthly and volume fees to provide the service to its members. The primary focus for the financial institution might be to encourage its members to push information for a credit card that is issued by the financial institution (or a credit card issuer affiliated with the financial institution) to as many online vendors as possible, and to make such a credit card a default payment method for as many of its members as possible.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

The tools provided by various embodiments include, without limitation, methods, systems, and/or software products. Merely by way of example, a method might comprise one or more procedures, any or all of which might be executed by a computer system. Correspondingly, an embodiment might provide a computer system configured with instructions to perform one or more procedures in accordance with methods provided by various other embodiments. Similarly, a computer program might comprise a set of instructions that are executable by a computer system, or by a processor located in the computer system, to perform such operations. In many cases, such software programs are encoded on physical, tangible, and/or non-transitory computer readable media. Such computer readable media might include, to name but a few examples, optical media, magnetic media, and the like.

Various embodiments described herein, while embodying (in some cases) software products, computer-performed methods, and/or computer systems, represent tangible, concrete improvements to existing technological areas, including, without limitation, network communications technology, application access and input technology, remote application access and input technology, and/or the like. In other aspects, certain embodiments, can improve the functioning of a computer or network system itself (e.g., computing devices or systems that form parts of the network, computing devices or systems for performing the functionalities described below, etc.), for example, by facilitating efficiency and data transfer during payment/account information pushing or updating processes, thereby improving network and/or computing system functionalities or improving network and/or computing system efficiencies (by avoiding tie-ups in terms of bandwidth, access ports, time, and/or the like that can occur with a user trying to access, individually determine how to update his or her payment/account information on the disparate on-line user account/vendor account systems associated with the multiple vendors, and later trying to enter in the updated payment/account information on the disparate on-line user account/vendor account systems associated with the multiple vendors; and/or the like), and/or the like.

In particular, to the extent any abstract concepts are present in the various embodiments, those concepts can be implemented as described herein by devices, software, systems, and methods that involve specific novel functionality (e.g., steps or operations), such as implementation of automatic (and, in some cases, automatic and concurrent) pushing of payment/account information to each of multiple user accounts associated with the user and with multiple vendor websites associated with multiple vendors, whether to add, modify, or delete such information or to add, modify, or delete one or more user accounts, and/or the like, to name a few examples, that extend beyond mere conventional computer processing operations. Various non-limiting embodiments of automatic pushing or updating of payment/account information are described herein. These functionalities can produce tangible results outside of the implementing computer system, including, merely by way of example, ability to automatically push or update a user's payment/account information to multiple user accounts associated with multiple vendor websites associated with multiple vendors (and, in some cases, implemented in a concurrent manner), thereby achieving improved network and/or computing system operations or improved network and/or computing system operation efficiencies (by avoiding tie-ups in terms of bandwidth, access ports, time, and/or the like that can occur with a user trying to access, individually determine how to update his or her payment/account information on the disparate on-line user account/vendor account systems associated with the multiple vendors, and later trying to enter in the updated payment/account information on the disparate on-line user account/vendor account systems associated with the multiple vendors; and/or the like), and/or the like, any of which may be observed or measured by customers and/or service providers.

In an aspect, a method might be provided for implementing automatic updating of payment information associated with users to multiple vendor websites. The method might comprise providing a user interface to a user device associated with a user via an account management application running on the user device, the user interface enabling the user to manage a plurality of user accounts with vendors, the plurality of user accounts being associated with the user. The method might also comprise receiving, with the user interface of the account management application, a first set of inputs and a second set of inputs, from the user. The first set of inputs might comprise instructions to push payment information associated with the user, while the second set of inputs might comprise instructions indicating two or more user accounts for at least two vendor websites of a plurality of vendor websites, with which the payment information is to be updated. Each user account might be associated with the user and with one vendor website of the plurality of vendor websites. The method might further comprise automatically concurrently pushing, with the account management application and over one or more networks in communication with at least each of the at least two vendor websites, the payment information to the two or more user accounts, in response to receiving the first and second sets of inputs from the user. Each of the two or more user accounts might be associated with the two or more vendor websites.

According to some embodiments, the payment information associated with the user might comprise at least one of credit card information, debit card information, or billing information associated with the user, and/or the like. In some cases, the billing information associated with the user might comprise at least one of name of the user, username of the user, password of the user, a billing address, one or more mailing addresses, one or more e-mail addresses, or one or more telephone numbers, and/or the like. In some instances, the user device might include, but is not limited to, a gaming console, a DVR, a STB, one or more TVs, a desktop computer, a laptop computer, a tablet computer, a smart phone, a mobile phone, a portable gaming device, and/or the like.

In some embodiments, automatically concurrently pushing the payment information to the two or more user accounts might comprise automatically concurrently pushing, with the account management application via a server computer in the one or more networks and over one or more networks in communication at least with the server computer and with each of the at least two vendor websites, the payment information to the two or more user accounts, in response to receiving the first and second sets of inputs from the user, each user account being associated with the two or more vendor websites. In some cases, the server computer might be associated with a web-based service provider. In some instances, the server computer might be associated with a financial institution. According to some embodiments, the payment information associated with the user might comprise credit card information of a credit card associated with the user, and the credit card associated with the user might be at least one of associated with the financial institution or issued by the financial institution. In some cases, the server computer might be associated with a credit card company. In some instances, the server computer might be associated with a non-financial institution—including, but not limited to, a merchant, a platform entity (including, without limitation, a search engine provider, a browser provider, etc.), a credit card processor (e.g., Visa®, Mastercard®, Discover®, American Express®, and/or the like), and/or the like.

Merely by way of example, in some instances, at least one of the two or more user accounts might be an existing account on a corresponding one vendor website of the plurality of vendor websites. In such cases, automatically concurrently pushing the payment information might comprise updating the payment information on the existing account on the corresponding one vendor website. In some embodiments, at least one of the two or more user accounts might be a new account on a corresponding one vendor website of the plurality of vendor websites. In such instances, automatically concurrently pushing the payment information might comprise establishing, with the computer, a new account associated with the user on one or more vendor websites, and pushing, with the computer, the payment information to the newly established account on each of the one or more vendor websites.

According to some embodiments, the plurality of vendor websites might comprise at least one of one or more retail websites, one or more service websites, one or more subscription websites, or one or more payment service websites. The one or more retail websites might comprise websites associated with product retailers. The one or more service websites might comprise websites associated with service providers, which might comprise at least one of utility service providers, on-line service providers, or other service providers. The one or more subscription websites might comprise websites associated with companies that provide one or more of products or services that require a paid subscription for access by the user. The one or more payment service websites might comprise websites associated with services that facilitate payment on other websites to purchase at least one of services or products. In some embodiments, the one or more payment service websites might comprise one or more billpay service websites that facilitate recurring payment of bills for one or more of services or products purchased by the user.

In some embodiments, the method might further comprise receiving, with the user interface of the account management application, a third set of inputs from the user. The third set of inputs might comprise instructions for managing a plurality of credit cards associated with the user. In some instances, instructions for managing the plurality of credit cards associated with the user might comprise at least one of instructions for adding one or more new credit cards, instructions for deleting one or more existing credit cards, or instructions for updating information for one or more existing credit cards, and/or the like.

According to some embodiments, the method might further comprise receiving, with the user interface of the account management application, a fourth set of inputs from the user. The fourth set of inputs might comprise instructions for managing one or more accounts associated with the user on one or more vendor websites associated with one or more vendors of a plurality of vendors. In some cases, instructions for managing the one or more accounts might include, without limitation, at least one of instructions to add accounts, instructions to update account information, instructions to delete accounts, and/or the like.

In some instances, automatically concurrently pushing the payment information might comprise automatically concurrently pushing the payment information to the two or more user accounts corresponding to the at least two vendor websites of the plurality of vendor websites, via application programming interfaces (“APIs”) associated with each of the corresponding at least two vendor websites. According to some embodiments, automatically concurrently pushing the payment information to the two or more user accounts corresponding to the at least two vendor websites of the plurality of vendor websites, via APIs associated with each of the corresponding at least two vendor websites, might comprise determining, with the account management application, an API for each of the at least two vendor websites, and automatically concurrently pushing the payment information to each of the two or more user accounts associated with the at least two of the plurality of vendor websites, via the determined API for each of the at least two vendor websites.

In some cases, at least one of the plurality of vendor websites might operate without APIs, and automatically concurrently pushing the payment information might comprise automatically concurrently pushing the payment information to the two or more user accounts associated with the at least two vendor websites of the plurality of vendor websites, by entering the payment information using screen scraping (which might be bi-directional—i.e., screen scraping to pull data from the vendor website (e.g., from a form or from a webpage of the vendor website) and/or screen scraping to enter data into the vendor website (e.g., into a form or into a webpage of the vendor website). According to some embodiments, automatically concurrently pushing the payment information to the two or more user accounts associated with the at least two vendor websites of the plurality of vendor websites, by entering the payment information using screen scraping, might comprise determining, with the account management application, portions of each of the at least two vendor websites corresponding to portions of the payment information being pushed, and automatically concurrently pushing the payment information to each of the two or more user accounts associated with the at least two of the plurality of vendor websites, by using screen scraping to enter the portions of the payment information into determined corresponding portions of each of the at least two vendor websites.

In some embodiments, automatically concurrently pushing the payment information might comprise determining, with the account management application, processes by which each of the at least two vendor websites updates payment information, and automatically concurrently pushing the payment information to the two or more user accounts associated with the at least two of the plurality of vendor websites, based at least in part on the determined processes by which each of the at least two vendor websites updates payment information.

Merely by way of example, in some aspects, the method might further comprise storing, on one or more data stores, one or more of at least a portion of the payment information associated with the user or at least a portion of information associated with the two or more user accounts.

In another aspect, an apparatus might be provided for implementing automatic updating of payment information associated with users to multiple vendor websites. The apparatus might comprise a non-transitory computer readable medium in communication with at least one processor. The computer readable storage medium might have stored thereon computer software. The computer software might comprise a set of instructions that, when executed by the at least one processor, causes the apparatus to: provide a user interface to a user device associated with a user via an account management application running on the user device, the user interface enabling the user to manage a plurality of user accounts with vendors, the plurality of user accounts being associated with the user; receive, with the user interface of the account management application, a first set of inputs from the user, the first set of inputs comprising instructions to push payment information associated with the user; receive, with the user interface of the account management application, a second set of inputs from the user, the second set of inputs comprising instructions indicating two or more user accounts for at least two vendor websites of a plurality of vendor websites with which the payment information is to be updated, each user account being associated with the user and with one vendor website of the plurality of vendor web sites; and automatically concurrently push, with the account management application and over one or more networks in communication with at least each of the at least two vendor websites, the payment information to the two or more user accounts, in response to receiving the first and second sets of inputs from the user, the two or more user accounts being associated with the at least two vendor websites of the plurality of vendor websites.

In yet another aspect, a system might be provided for implementing automatic updating of payment information associated with users to multiple vendor websites. The system might comprise a data storage device and a computer in communication with the data storage device. The computer might comprise at least one processor and a computer readable medium in communication with the at least one processor. The computer readable storage medium might have stored thereon computer software. The computer software might comprise a set of instructions that, when executed by the at least one processor, causes the computer to: provide a user interface to a user device associated with a user via an account management application running on the user device, the user interface enabling the user to manage a plurality of user accounts with vendors, the plurality of user accounts being associated with the user; receive, with the user interface of the account management application, a first set of inputs from the user, the first set of inputs comprising instructions to push payment information associated with the user; store at least a portion of the payment information associated with the user on the data storage device; receive, with the user interface of the account management application, a second set of inputs from the user, the second set of inputs comprising instructions indicating two or more user accounts for at least two vendor websites of a plurality of vendor websites with which the payment information is to be updated, each user account being associated with the user and with one vendor website of the plurality of vendor websites; store at least a portion of information associated with the two or more user accounts on the data storage device; and automatically concurrently push, with the account management application and over one or more networks in communication with at least each of the at least two vendor websites, the payment information to the two or more user accounts, in response to receiving the first and second sets of inputs from the user, the two or more user accounts being associated with the at least two vendor websites of the plurality of vendor websites.

In still another aspect, a method might be provided for implementing automatic updating of payment information associated with users to multiple vendor websites. The method might comprise automatically concurrently pushing, with a computer, at least one of credit card information or billing information associated with a user to a plurality of user accounts of a plurality of vendor websites, the user accounts being associated with the user, in response to receiving input from the user.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### Specific Exemplary Embodiments

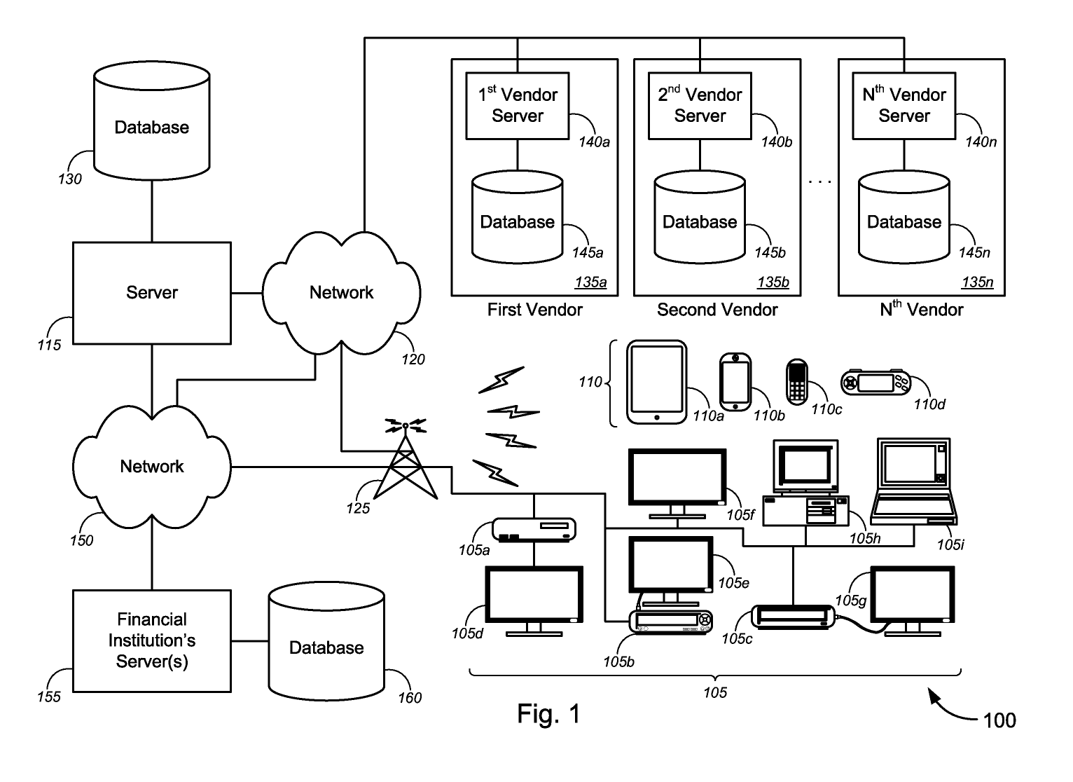

We now turn to the embodiments as illustrated by the drawings. FIGS. 1-7 illustrate some of the features of the method, system, and apparatus for implementing automatic updating or pushing of payment information (which, herein, includes, without limitation, credit card data, other payment information, account information, billing information, and/or the like) to multiple retail and payment websites, as referred to above. The methods, systems, and apparatuses illustrated by FIGS. 1-7 refer to examples of different embodiments that include various components and steps, which can be considered alternatives or which can be used in conjunction with one another in the various embodiments. The description of the illustrated methods, systems, and apparatuses shown in FIGS. 1-7 is provided for purposes of illustration and should not be considered to limit the scope of the different embodiments.

With reference to the figures, FIG. 1 is a general schematic diagram illustrating a system 100 for implementing automatic updating or pushing of payment information (which, herein, includes, without limitation, credit card data, other payment information, account information, billing information, and/or the like) to multiple retail and payment sites, in accordance with various embodiments. In FIG. 1, system 100 might comprise two or more user devices 105. The two or more user devices 105 might comprise gaming console 105a, digital video recording and playback device (“DVR”) 105b, set-top or set-back box (“STB”) 105c, one or more television sets (“TVs”) 105d-105g, desktop computer 105h, laptop computer 105i, and one or more mobile user devices 110. The one or more TVs 105d-105g might include any combination of a high-definition (“HD”) television, an Internet Protocol television (“IPTV”), and a cable television, or the like, where one or both of HDTV and IPTV may be interactive TVs. The one or more mobile user devices 110 might comprise one or more tablet computers 110a, one or more smart phones 110b, one or more mobile phones 110c, or one or more portable gaming devices 110d, and/or the like.

System 100 might further comprise server 115 communicatively coupled to the two or more user devices 105 via network 120 and/or network 150, and in some cases via one or more telecommunications relay systems 125. The one or more telecommunications relay systems 125 might include, without limitation, one or more wireless network interfaces (e.g., wireless modems, wireless access points, and the like), one or more towers, one or more satellites, and the like. System 100 might further comprise database 130 in communication with server 115.

In some embodiments, system 100 might further comprise a plurality of vendors 135, which might include a first vendor 135a, a second vendor 135b, through an N^{th} vendor 135n. Herein, “vendor” might refer to a financial institution or a non-financial institution. A financial institution might include, but is not limited to, a bank, a credit union, a trust company, a mortgage loan company, an insurance company, an investment bank, an underwriting company, a brokerage firm, and/or the like. A non-financial institution might include, without limitation, a retailer, a product provider, a service provider, a subscription based company, a payment service provider, a credit card company, a platform entity (including, but not limited to, a search engine provider, a browser provider, and/or the like), and/or the like. Each vendor 135 might have an associated server(s) 140 and an associated database 145. For example, the first vendor 135a might have server 140a and database 145a associated therewith, the second vendor 135b might have server 140b and database 145b associated therewith, and so on through the N^{th} vendor 135n, which might have server 140n and database 145n associated therewith. Each vendor server 140a-140n—which might host a vendor web site associated with a corresponding or associated vendor 135a-135n—might be in communication with at least one of the server 115 and/or the two or more user devices 105 via network 120 and/or via the one or more telecommunications relay systems 125. System 100 might further comprise server 155 and database 160 in communication with server 115 and/or with one or more of the plurality of vendor servers 140.

In operation, server 115 might perform the methods described in detail with respect to FIGS. 2-4 below, while data associated with user account(s) with a management service provider (with which server 115 might be associated), data associated with user account(s) with one or more financial institutions (with which financial institutions' servers 155 might be associated), data associated with one or more vendors 135 (with which servers 140 might be associated), data associated with one or more credit cards (with which the user might be associated), and/or data associated with billing information (with which the user might be associated) might be collected by the two or more user devices 105, by server 115, by server 155, or by any combination of these computing devices. The database 130 (and/or database 160) might store some or all of these collected data.

Although the embodiment of FIG. 1 is described with respect to a financial institution or financial institution's server(s) 155 performing one or more functions of the methods described in detail with respect to FIGS. 2-4 below, the various embodiments are not so limited, and server 155 might be a server associated with a non-financial institution or entity that performs the one or more functions of the methods of FIGS. 2-4. The non-financial institution or entity might include, without limitation, a merchant, a platform entity (including, without limitation, a search engine provider, a browser provider, etc.), a credit card processor (e.g., Visa®, Mastercard®, Discover®, American Express®, etc.), and/or the like.

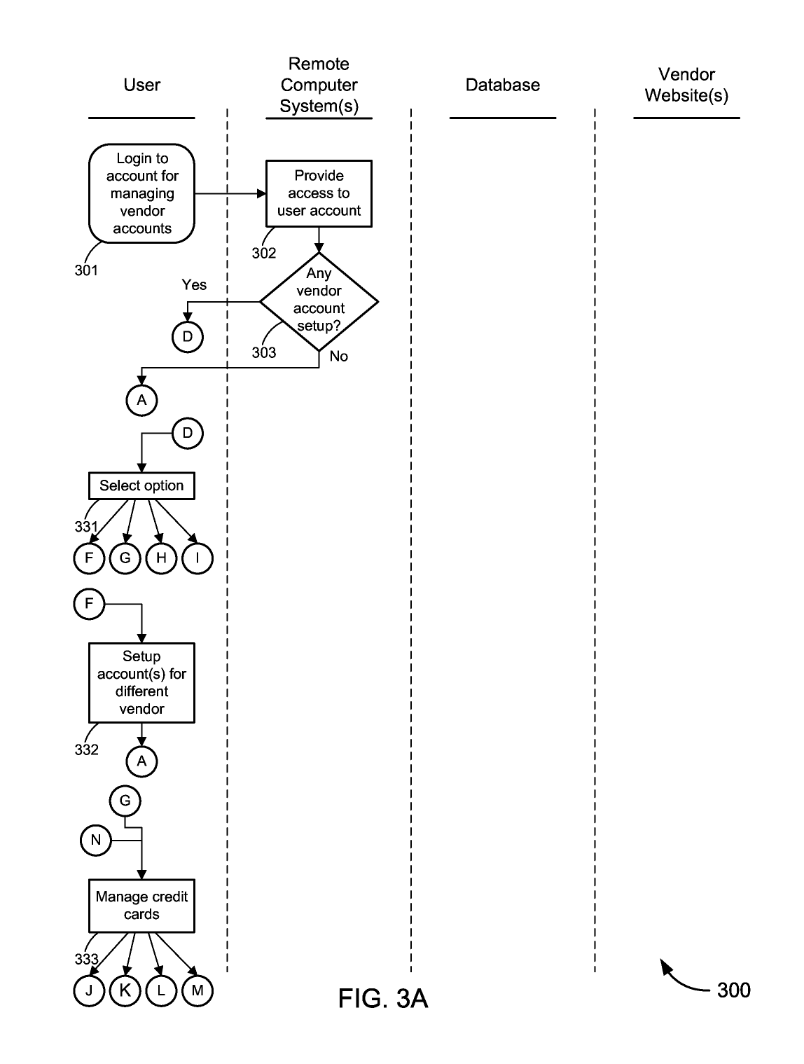

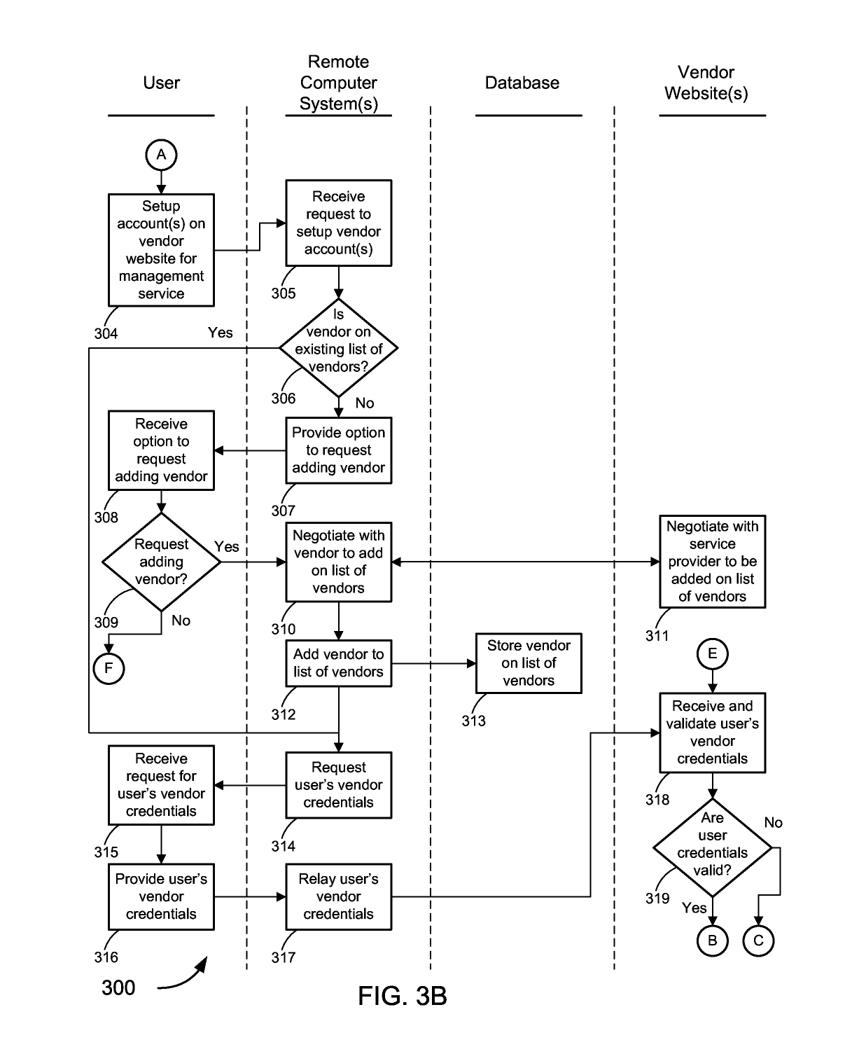

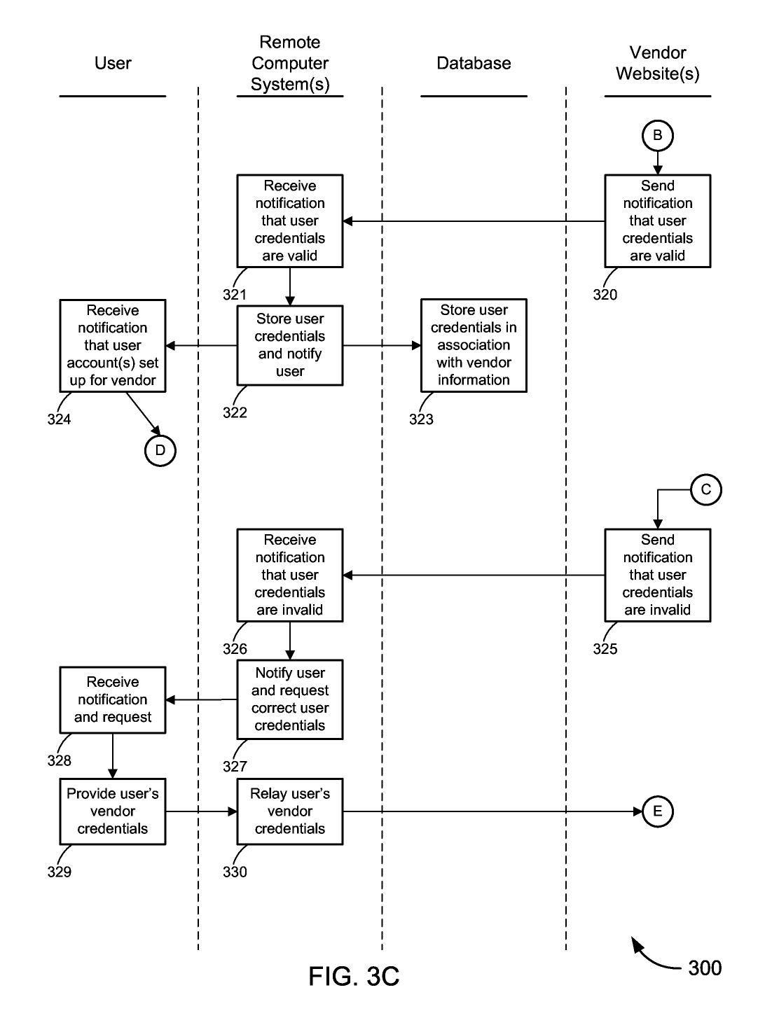

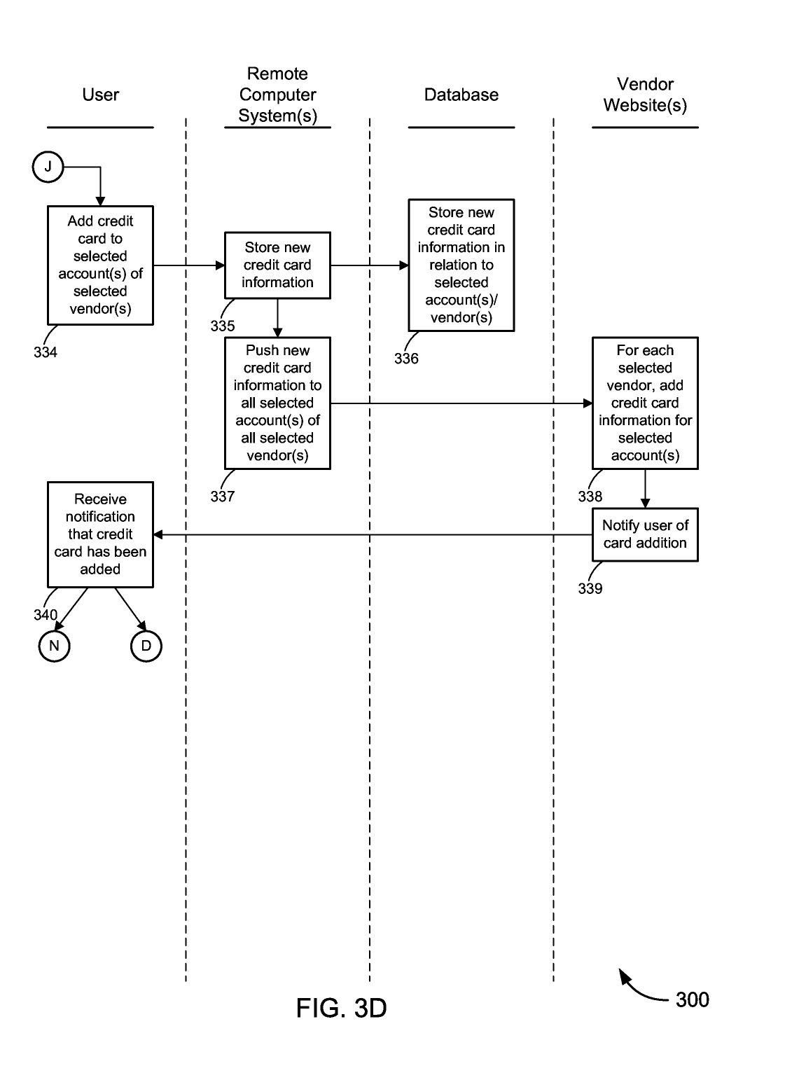

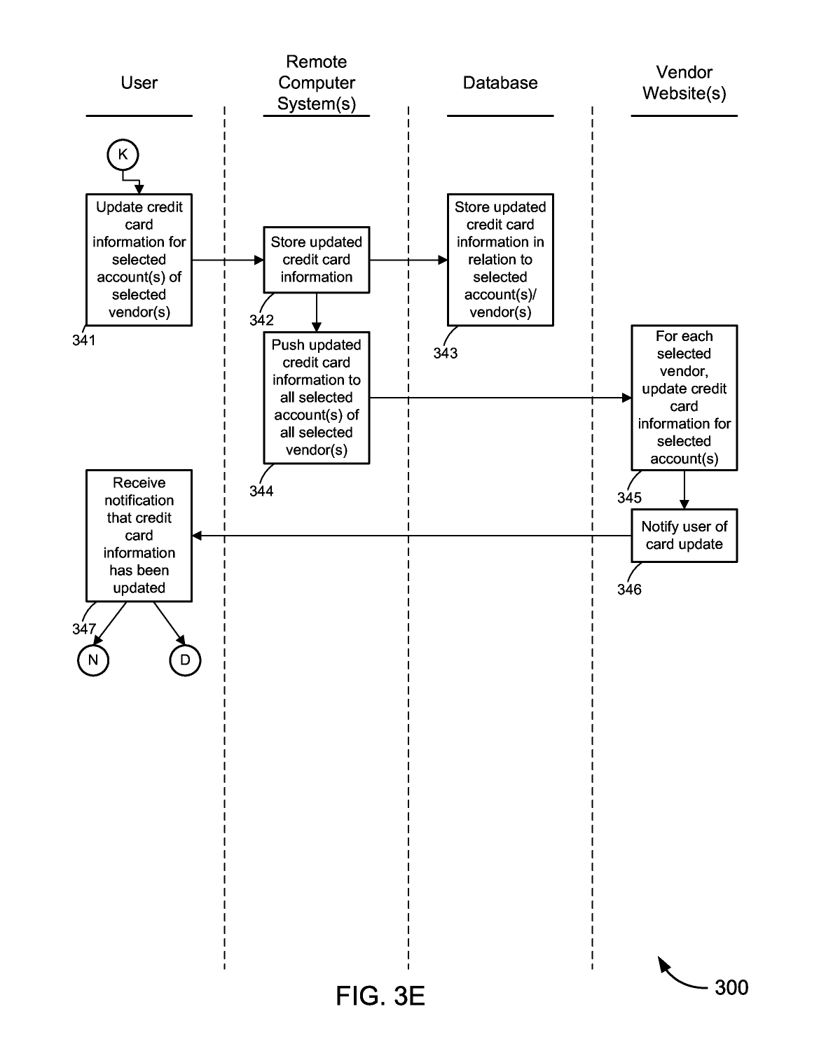

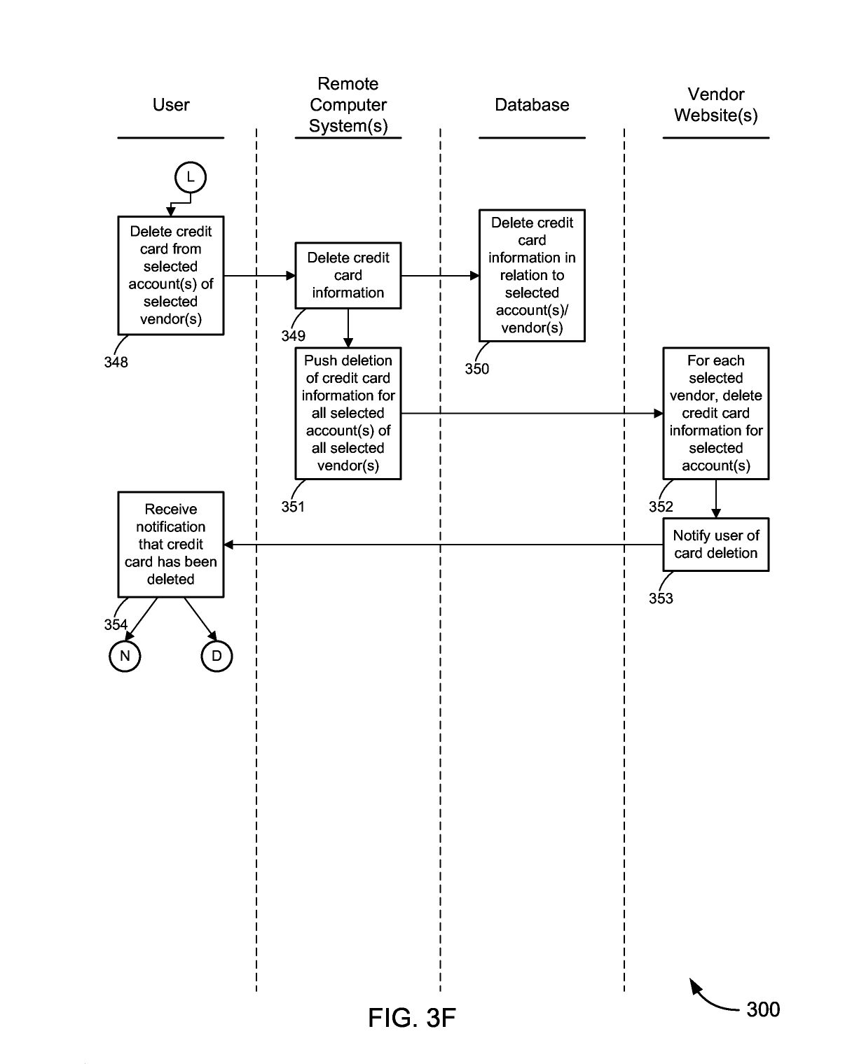

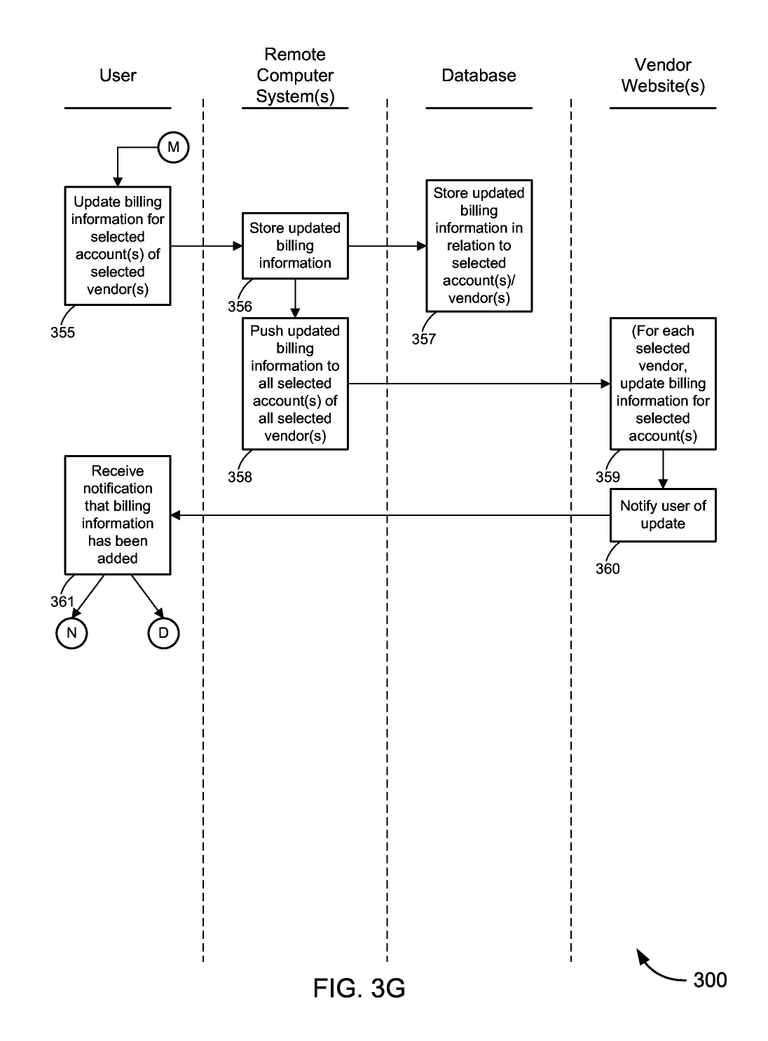

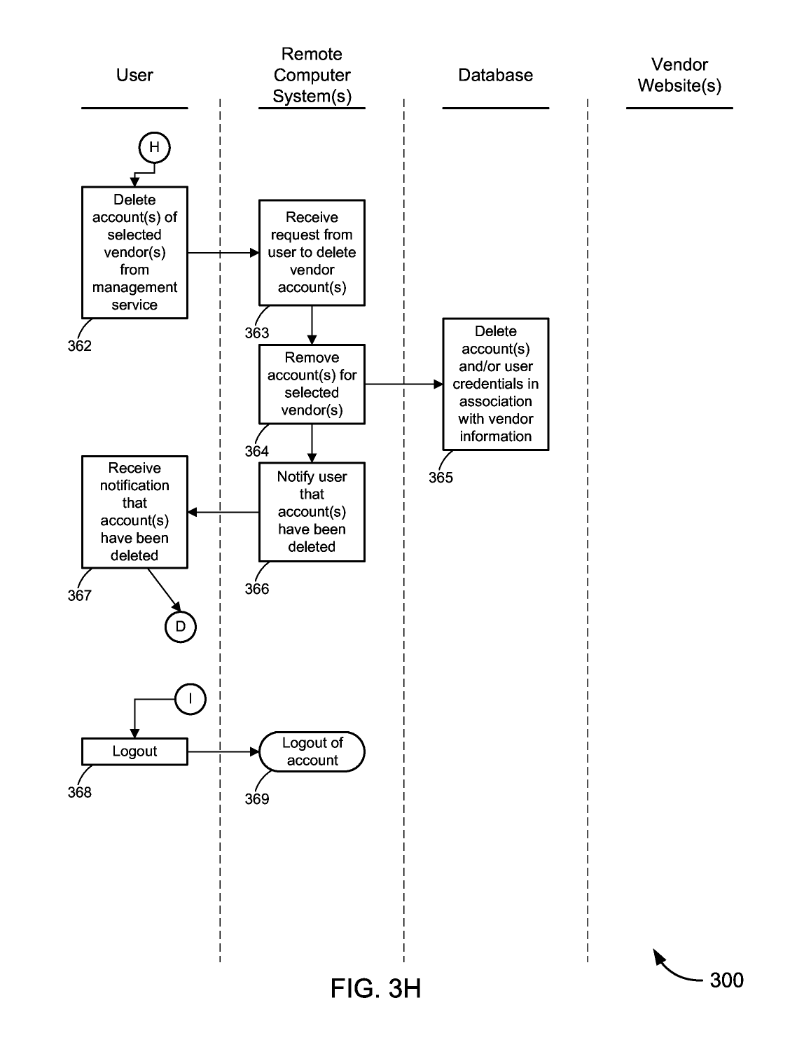

We now turn to FIGS. 2-4, which are directed to methods 200-400 for implementing automatic updating or pushing of payment information (which, herein, includes, without limitation, credit card data, other payment information, account information, billing information, and/or the like) to multiple retail and payment sites, in accordance with various embodiments. While the techniques and procedures of the methods 200, 300, and 400 are depicted and/or described in a certain order for purposes of illustration, it should be appreciated that certain procedures may be reordered and/or omitted within the scope of various embodiments. Moreover, while the methods illustrated by FIGS. 2-4 can be implemented by (and, in some cases, are described below with respect to) systems 100 of FIG. 1 (or components thereof), the method may also be implemented using any suitable hardware implementation. Similarly, while system 100 (and/or components thereof) can operate according to the methods illustrated by FIGS. 2, 3, and/or 4 (e.g., by executing instructions embodied on a computer readable medium), system 100 can also operate according to other modes of operation and/or perform other suitable procedures.

FIGS. 2A-2C (collectively, “FIG. 2”) are general schematic flow diagrams illustrating a method 200 for implementing automatic updating or pushing of payment information to multiple retail and payment sites, in accordance with various embodiments. With reference to FIG. 2A, method 200 might comprise receiving, with a computer (e.g., with server 115 and/or server 155 shown in FIG. 1) and from a user (e.g., with user device(s) 105 shown in FIG. 1), a first set of inputs comprising instructions to push payment information associated with the user (block 205), and receiving, with the computer and from the user, a second set of inputs comprising instructions indicating two or more user accounts (which are associated with the user), with which the payment information is to be updated (block 210). Each of the two or more user accounts might be associated with one vendor website of a plurality of vendor websites (which might be hosted by associated or corresponding vendor servers 140 shown in FIG. 1). In some instances, the instructions indicating two or more user accounts might include, without limitation, instructions indicating which of a plurality of vendors the user intends to update payment information with (i.e., “selected vendor(s)”) and instructions indicating which account(s) with the selected vendor(s) the user intends to update payment information with.

At block 215, method 200 might further comprise automatically concurrently pushing, with the computer, the payment information to the two or more user accounts, in response to receiving the first and second sets of inputs from the user. Each of the two or more user accounts might be associated with one vendor website of the plurality of vendor websites. According to some embodiments, the payment information might include, without limitation, account information, credit card information, debit card information, banking information, billing information, and/or the like. In some cases, the account information might comprise, for each relevant account (including, but not limited to, card/payment management service account, financial institution account, vendor account for each vendor, and/or the like) username of the user, password of the user, and/or the like. The credit card information might include, but is not limited to, type of credit card (e.g., Visa® credit card, Mastercard® credit card, American Express® credit card, Discover® card, and/or the like), credit card number, card security code, expiration date of the card, name of cardholder, and/or the like. Similarly, the debit card information might include, without limitation, type of debit card (e.g., Visa® debit card, Mastercard® debit card, and/or the like), credit card number, card security code, expiration date of the card, name of cardholder, and/or the like. Banking information might include, without limitation, name of bank, address of a bank branch, routing number for the bank, bank account number of the user, and/or the like. In some cases, banking information might include information of any type of financial institution (not limited to banks), including, but not limited to, credit unions, credit card companies, trust companies, and/or the like. Billing information might include, but is not limited to, name of the user, billing address of the user, mailing address of the user, telephone number(s) of the user, e-mail address(es) of the user, and/or the like. In some embodiments, two or more of the account information, the credit card information, the debit card information, the banking information, and/or the billing information might include overlapping information and/or overlapping types of information. In some cases, the overlapping information (and/or overlapping types of information) might include at least some of the same information (and/or at least some of the same types of information).

According to some embodiments, the process of pushing the payment information of block 215 might comprise establishing, with the computer, a new account(s) associated with the user on the one or more vendor websites (block 220) and pushing, with the computer, the payment information to the newly established account(s) on each of the one or more vendor websites (block 225). In some embodiments, the process of pushing the payment information of block 215 might comprise logging into, with the computer, each selected existing account on each of the selected vendor websites (block 230) and pushing, with the computer, the payment information to the selected existing account(s) on each of the selected vendor websites (block 235). In these embodiments, when accessing the user's account on the computer—that is, a card/payment management service provider system (e.g., server 115 of FIG. 1) or a financial institution's system (e.g., server 155 of FIG. 1)—the user might be provided a list of existing vendor websites (of which the user has previously provided account information and user credentials, and of which the card/payment management service provider has established a connection/relationship/etc.) and a list of accounts for each existing vendor website associated with the user, and the user might be given the option to select one or more of the listed vendors and one or more of the listed accounts.

In some embodiments, method 200, at block 240, might comprise storing, with the computer, payment information and/or account information associated with the user in a data storage device(s) (e.g., database 130 and/or database 160 shown in FIG. 1) that is in communication with the computer.

Turning to FIG. 2B, method 200 might further comprise, at block 245, receiving, with the computer and from the user, a third set of inputs comprising instructions for managing a plurality of credit cards associated with the user. In some embodiments, instructions for managing a plurality of credit cards associated with the user might comprise one or more of instructions to add one or more new credit cards (block 250), instructions to update credit card information (e.g., updating expiration date of credit cards, setup a particular credit card as a default payment method, etc.) (block 255), instructions to delete one or more existing credit cards (block 260), and/or instructions to update billing information (e.g., billing address, name of user, etc.) (block 265) on existing accounts on all selected vendor websites. At block 230′, method 200 might comprise logging into, with the computer, each selected existing account on each of the selected vendor websites. Method 200 might, at block 235′, comprise pushing, with the computer, the credit card information (i.e., payment information) to the selected existing account(s) on each of the selected vendor websites. Method 200 might further comprise, at block 240′, storing, with the computer, credit card information (i.e., payment information) associated with the user in a data storage device(s) (e.g., database 130 and/or database 160 shown in FIG. 1) that is in communication with the computer. Although FIG. 2B is described with respect to credit card information, the embodiments are not so limited and the various embodiments may also be applicable to debit card information, checking account information of a financial institution (including, without limitation, a bank, a credit union, a credit card company, trust companies, and/or the like), savings account information of a financial institution, and/or the like.

Referring to FIG. 2C, method 200, at block 270, might comprise receiving, with the computer and from the user, a fourth set of inputs comprising instructions for managing one or more accounts associated with the user on one or more vendor websites associated with one or more vendors of a plurality of vendors. According to some embodiments, the instructions for managing the one or more accounts might comprise instructions to add one or more new accounts on one or more selected vendor websites (block 275), instructions to update account information (e.g., username(s), password(s), account identification (“ID”), account nickname(s), and/or the like) on existing accounts on all selected vendor websites (block 280), instructions to delete one or more existing accounts on one or more selected vendor websites (block 285), and/or the like.

Method 200 might further comprise, at block 230″, logging into, with the computer, each selected existing account on each of the selected vendor websites. At block 235″, method 200 might comprise pushing, with the computer, the account information (i.e., payment information) to the selected existing account(s) on each of the selected vendor websites. Method 200 might further comprise storing, with the computer, account information (i.e., payment information) associated with the user in a data storage device(s) (e.g., database 130 and/or database 160 shown in FIG. 1) that is in communication with the computer (block 240″).

In some embodiments, an application (“App”) running on a user device might provide a user interface, which might provide information or access to the user's account(s), user profiles, etc. that are hosted on a server over a network. The server might perform one, more, or all functions performed by the computer as indicated in the processes of method 200. In some instances, the user interface running on the user device might be a non-App-based user interface.

Although the embodiments of FIG. 2 above have been described from the perspective of the computer being one of server 115 or server 155 shown in FIG. 1 (or other server over a network), the various embodiments are not so limited, and the computer performing the processes of FIG. 2 may include a user device associated with the user, such as a user device including user device 105 of FIG. 1, which includes, but is not limited to, a gaming console, a DVR, a STB, one or more TVs, a desktop computer, a laptop computer, a tablet computer, a smart phone, a mobile phone, a portable gaming device, and/or the like. In some cases, an App running on the user device might serve to provide the user interface, while at the same time performing one, more, or all functions performed by the computer as indicated in the processes of method 200. In some instances, the user interface and/or software running on the user device might be a non-App-based user interface and/or software.

In some embodiments, at least one processor of the computer (which might include, without limitation, a server computer, a user device, or other computing device) might be specifically configured to cause—via appropriate software, code, or other instructions that are stored on non-transitory computer readable medium in communication with the at least one processor, and that when executed by the at least one processor cause—the computer to receive, from the user, the first set of inputs comprising instructions to push payment information associated with the user (at block 205); receive, from the user, the second set of inputs comprising instructions indicating two or more user accounts (which are associated with the user), with which the payment information is to be updated (at block 210); automatically concurrently push the payment information to the two or more user accounts, in response to receiving the first and second sets of inputs from the user (at block 215); establish a new account(s) associated with the user on the one or more vendor websites (at block 220); push the payment information to the newly established account(s) on each of the one or more vendor websites (at block 225); log into each selected existing account on each of the selected vendor websites (at block 230); push the payment information to the selected existing account(s) on each of the selected vendor websites (at block 235); store payment information and/or account information associated with the user in a data storage device(s) (e.g., database 130 and/or database 160 shown in FIG. 1) that is in communication with the computer (at block 240); and so on, as described above with respect to the processes of blocks 205 through 285, blocks 230′ through 240′, and blocks 230″ through 240″ of FIGS. 2A-2C. Accordingly, the at least one processor, the user device, and/or the computer thereby become a specialized processor(s), user device, and/or computer performing specialized functionalities, and not merely a generic processor, computer, or computer component performing generic computer functions.

Notwithstanding this point, the ordered combination of the processes in at least 205-215 (and, in some cases, the combination of the processes at blocks 205-215 and the processes at one or more of blocks 220 through 285, blocks 230′ through 240′, and blocks 230″ through 240″ of FIGS. 2A-2C) as a whole address the Internet-centric challenge of updating payment or account information associated with a user across multiple, oftentimes disparate on-line user account/vendor account systems associated with the multiple vendors. This is addressed by the automatic pushing or updating of the payment information (and/or account information) to the one or more user accounts that are associated with the one or more vendor websites of the plurality of vendor websites, as described herein and as recited in the claims. These are meaningful limitations that add more than generally linking the use of any abstract idea to the Internet, because they solve an Internet-centric problem with a claimed solution that is necessarily rooted in computer technology, and thus amounts to significantly more than any such abstract idea.

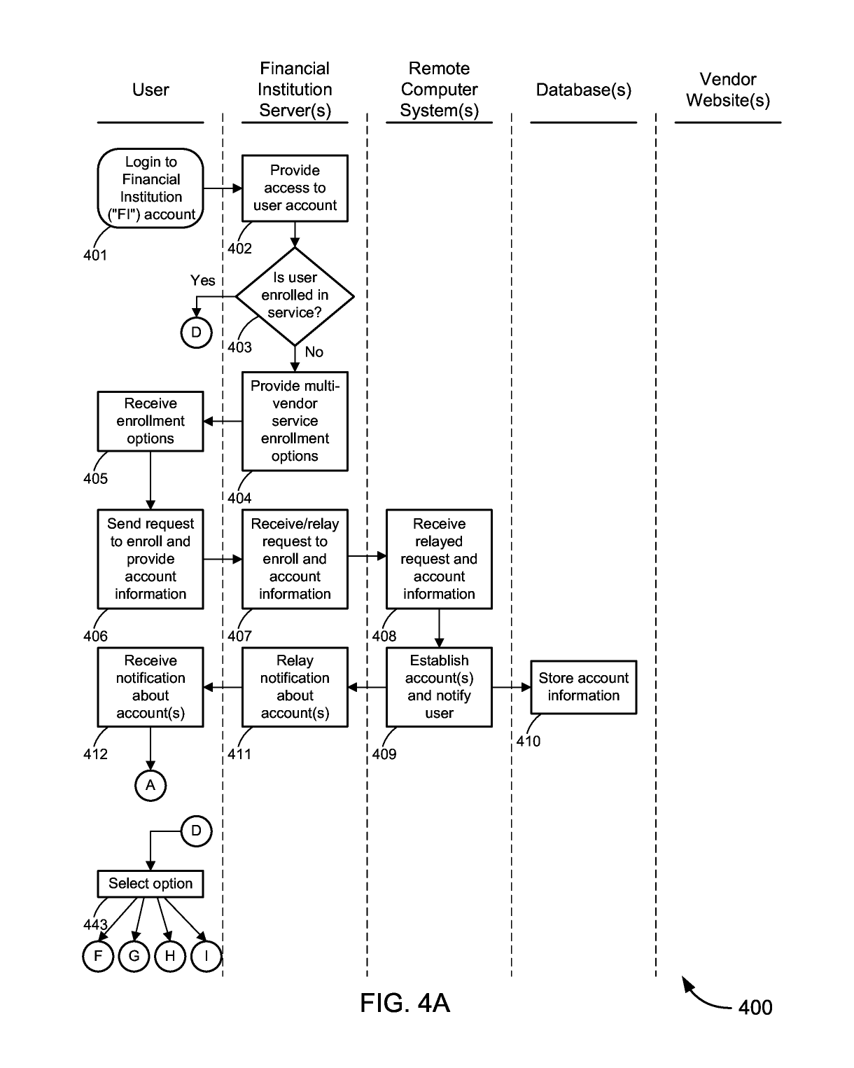

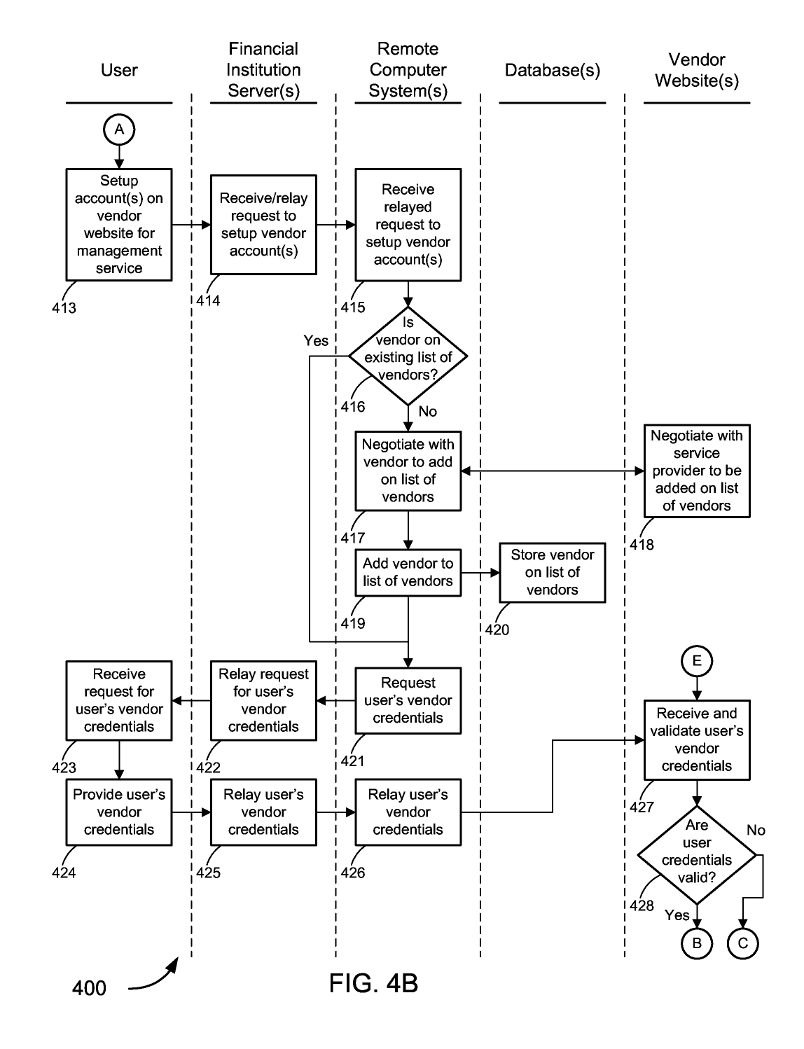

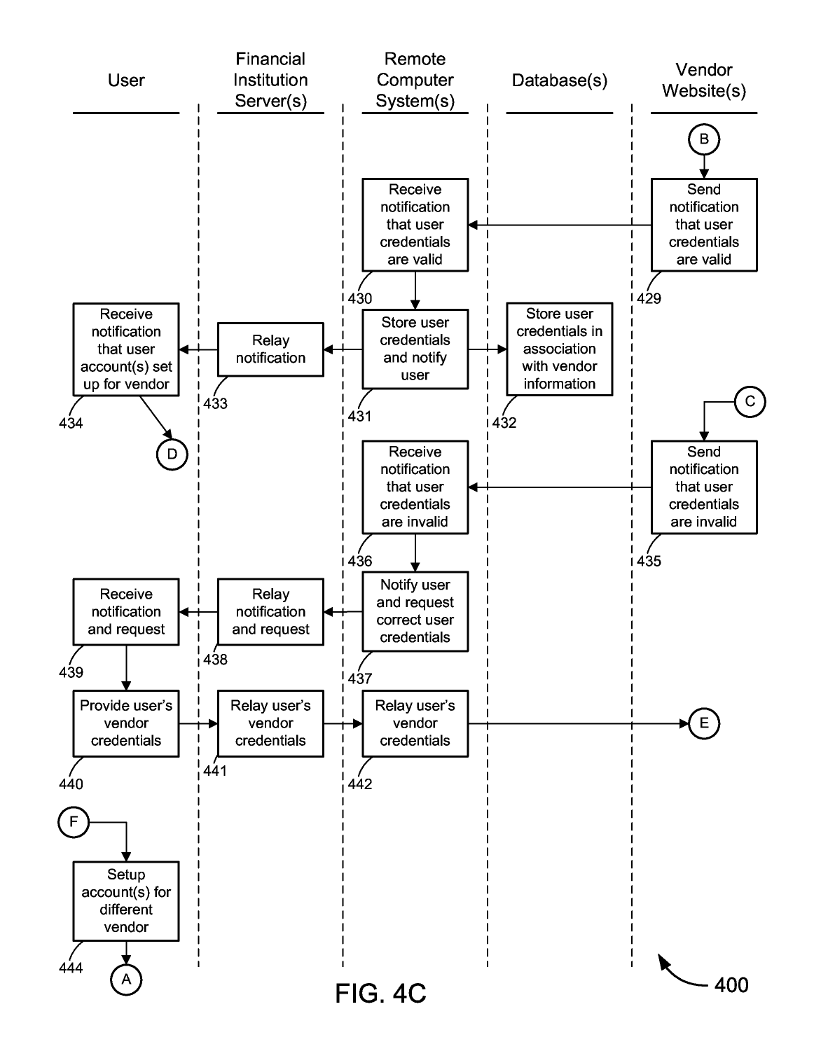

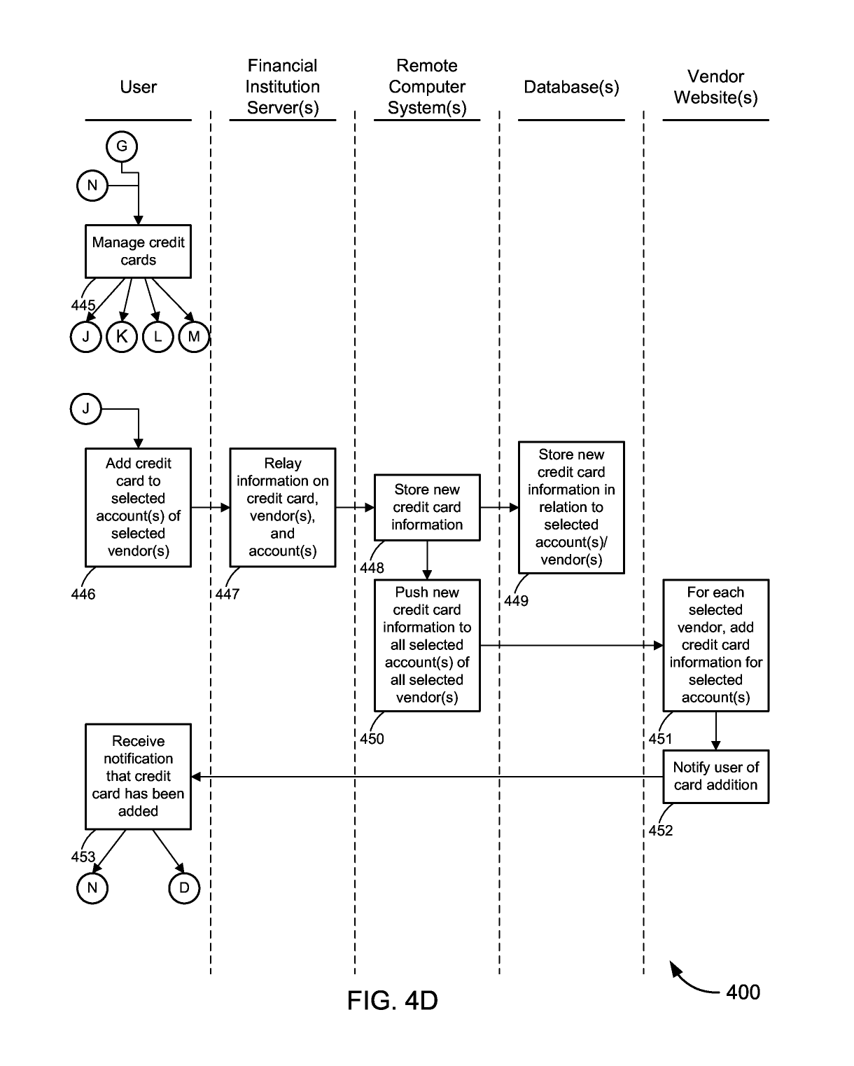

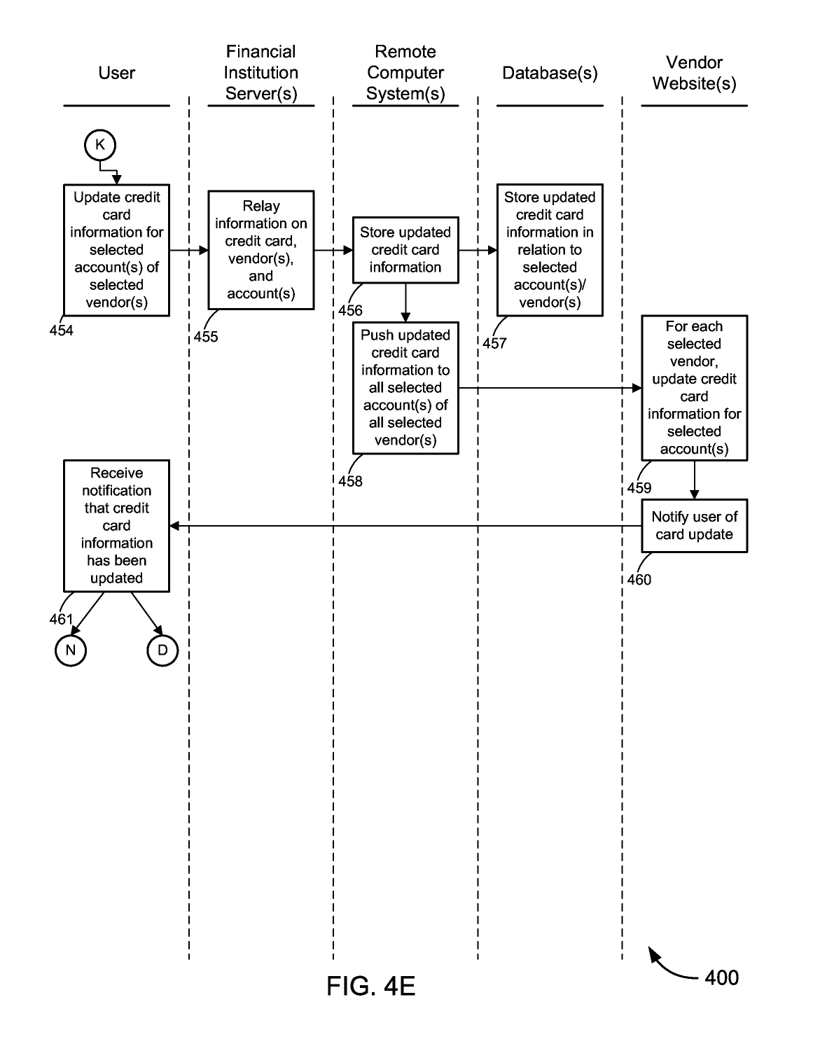

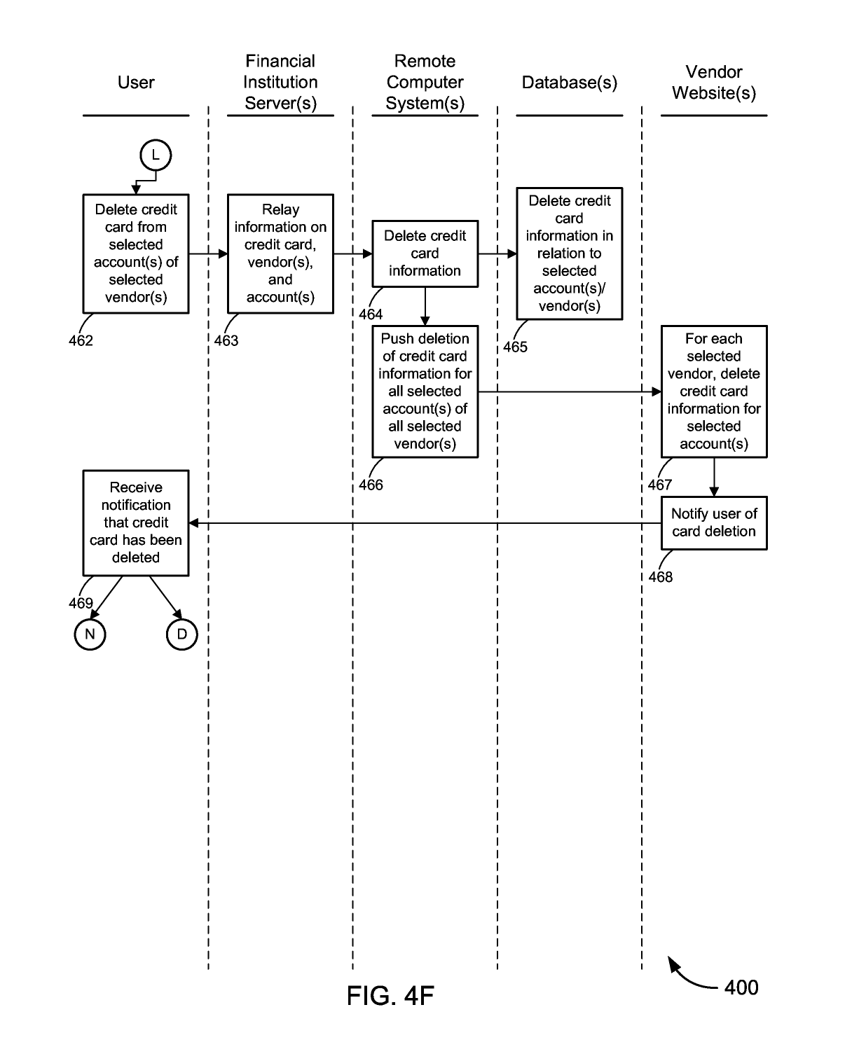

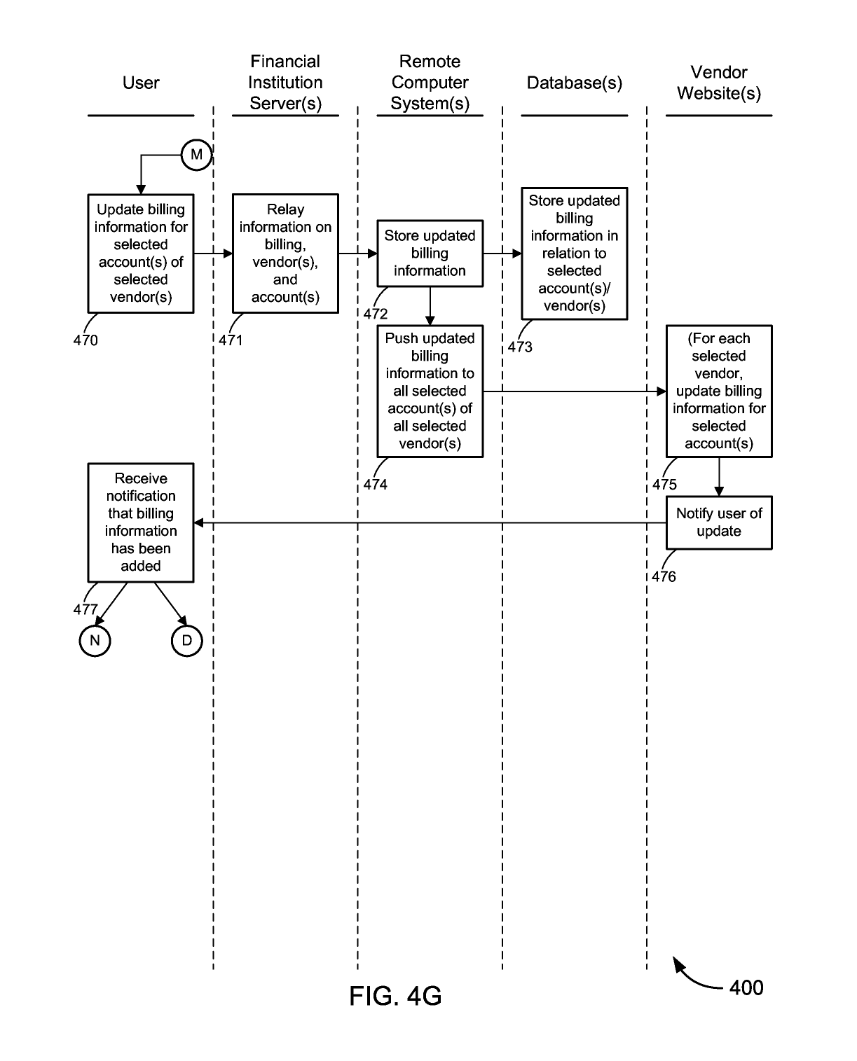

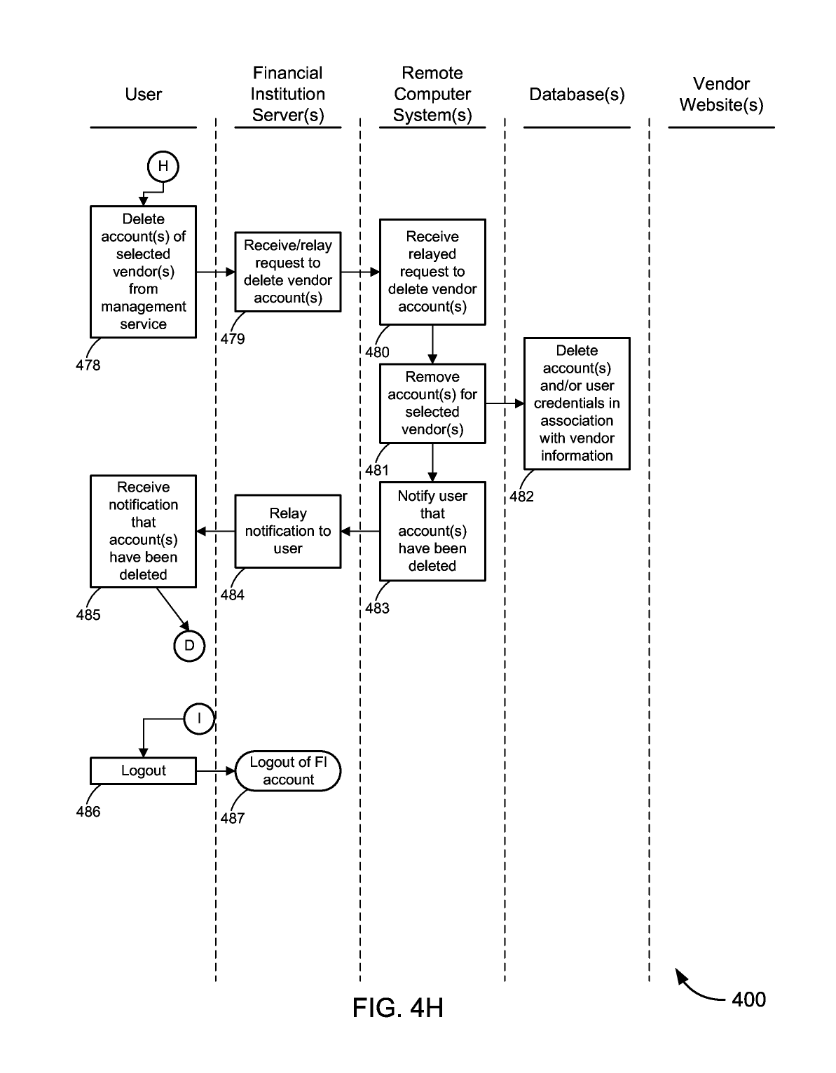

FIGS. 3A-3H (collectively, “FIG. 3”) represent a system flow diagram illustrating a method 300 for implementing automatic updating or pushing of payment information to multiple retail and payment sites, in accordance with various embodiments. FIGS. 4A-4H (collectively, “FIG. 4”) represent a system flow diagram illustrating another method 400 for implementing automatic updating or pushing of payment information to multiple retail and payment sites, in accordance with various embodiments. FIGS. 3 and 4 represent two alternative embodiments, with the former involving direct communication between a user and a card/payment management service provider, while the latter involves indirect communication via a financial institution. These embodiments, however, are merely illustrative and are not intended to limit the scope of the various embodiments.

With reference to FIG. 3, method 300 in FIG. 3A continues onto FIG. 3B, linked by the circular marker denoted by “A,” continues from FIG. 3B onto FIG. 3C linked by the circular markers denoted by “B” and “C,” and returns back from FIG. 3B to FIG. 3A linked by the circular marker denoted “F.” Method 300 in FIG. 3C returns back to FIG. 3A linked by the circular marker denoted “D” or returns back to FIG. 3B linked by the circular marker denoted “E.” Method 300 in FIG. 3A also continues onto FIG. 3H linked by the circular markers denoted “H” and “I,” and returns back to FIG. 3A linked by the circular marker denoted “D.” Method 300 in FIG. 3A additionally continues onto FIGS. 3D, 3E, 3F, and 3G linked by the circular markers denoted “J,” “K,” “L,” and “M,” respectively. Method 300 in FIGS. 3D, 3E, 3F, and 3G return back to FIG. 3A linked by the circular marker denoted “D” or “N.”

Turning to FIG. 3A, Method 300 might comprise logging into a user account for managing vendor accounts and/or for managing card and/or payment information on various vendor accounts on various vendor websites (block 301). In some cases, the user account might be an account for a card/payment management system of a card/payment management service provider. According to some embodiments, managing card information (and/or payment information) on various vendor accounts might be implemented in a “card-not-present” scenario, such as by logging into or otherwise accessing the various vendor accounts on various vendor websites. In some cases, managing card information (and/or payment information) might be implemented in a “card present” scenario, such as by presenting the card (and/or account information) to a representative of a vendor in a store or other physical location associated with the vendor (e.g., presenting a credit card issued in the name of a retail store to a cashier at the retail store, in order to manage card and/or payment information, or the like). At block 302, method 300 might comprise providing the user with access to the user account, with a remote computer system(s) (e.g., server 115 shown in FIG. 1, which might be associated with the card/payment management service provider). At block 303, a determination may be made by the remote computer system(s) as to whether any vendor account has been setup for the user. If so, the process proceeds to block 331 (following marker “D”). If not, the process proceeds to block 304 (following marker “A”).

With reference to FIG. 3B, method 300 might, at block 304, comprise the user providing instructions to set up one or more accounts on a vendor website, through the card/payment management service provider (i.e., through a website of the card/payment management service provider that is hosted by the remote computer system(s)). The remote computer system(s), at block 305, might receive the request to setup the one or more vendor accounts, and, at block 306, might determine whether the vendor is listed on an existing list of vendors compiled by the card/payment management service provider. In some cases, such a determination might include querying a database (such as database 130 shown in FIG. 1).

The list of vendors represents that each listed vendor has an existing connection or relationship with the card/payment management service provider. In some cases, the vendor(s) might have provided the card/payment management service provider with an application programming interface (“API”) for ease of transfer of information between server(s) of the vendor(s) and the remote computer system(s) of the card/payment management service provider. Even when such a connection or relationship exists, some vendors may lack APIs, in which case, screen scraping techniques (including bi-directional screen scraping for obtaining and for entering information from/to data fields in the servers of these vendors) may be implemented. In some embodiments, without any formal relationship or contract between the vendor and the card/payment management service provider, a connection between the server of the vendor and the remote computer system(s) might include the remote computer system(s) accessing a website interface running on the server of the vendor.

If it is determined that the vendor is on the list, the process might proceed to block 314. However, if it is determined that the vendor is not on the list, the process might proceed to block 307, which might provide the user with an option to request adding the vendor. At block 308, the user might receive the option to request adding the vendor. If the user decides, at block 309, not to request adding the vendor, the process proceeds to block 332 (following marker “F” to FIG. 3A). If the user decides, at block 309, to request adding the vendor, the process proceeds to block 310.

At blocks 310 and 311, the remote computer system(s) and the vendor website might negotiate with each other to try to add the vendor on the list of vendors, by establishing a connection or relationship (either by contract, by accessing the vendor website or server, by downloading an API for the vendor website or server, and/or the like). Once a connection has been established, the remote computer system(s) might add the vendor to the list of vendors (block 312), which might be stored on the database (block 313).

Turning to block 314, the remote computer system(s) might request, of the user, the user's credentials for accessing the user's account(s) on the vendor website or server, which request might be received by the user, at block 315. When the user provides the user's vendor credentials (block 316), the remote computer system(s) might relay the user's vendor credentials to the vendor website or server (block 317), which receives and validates the user's vendor credentials (block 318).

If the vendor website or server determines, at block 319, that the user credentials are valid, the process proceeds to block 320 (following marker “B” to FIG. 3C). At block 320, the vendor website or server might send a notification that the user credentials are valid, which, at block 321, might be received by the remote computer system(s). The remote computer system(s) might, at block 322, store the user credentials and notify the user, resulting in the user credentials being stored in association with the vendor information (and/or with the user's account with the card/payment management service provider) (block 323), and the user receiving a notification that the user account(s) has been set up for the vendor (block 324). The process then proceeds to block 331 in FIG. 3A (following marker “D”).

However, if the vendor website or server determines, at block 319, that the user credentials are invalid, the process proceeds to block 325 (following marker “C” to FIG. 3C). At block 325, the vendor website or server might send a notification that the user credentials are invalid, which, at block 326, might be received by the remote computer system(s). The remote computer system(s) might, at block 327, notify the user and might request the user provide correct user credentials. The user might receive the notification and request (block 328), and might provide (again), the user's vendor credentials (block 329), which might be relayed by the remote computer system(s) (block 330). The process then proceeds back to block 318 (following marker “E” back to FIG. 3B), and the process at blocks 319-324 or the process at blocks 319 and 325-330 may be repeated, as appropriate.

Although not shown in FIG. 3, if the number of times that the user enters invalid user credentials exceeds a predetermined number of tries (e.g., 3, 4, 5, or more times, etc.), the remote computer system(s) might notify the user of such and the process might automatically proceed to block 332 (following marker “F” to FIG. 3A). In some cases, the vendor website might, if the user entered a valid username (as part of the user credentials), notify the account holder (associated with the username, which may or may not be the user in FIG. 3) that the attempts have exceeded a threshold number of failed attempts to login and/or that the account has been locked for a predetermined period (e.g., 24 hours or more) and that the account holder should contact the vendor website administrator and/or wait until the predetermined period has passed before trying again.

At block 331, which may be reached if the user has already setup a vendor account (as determined at block 303), or if the user successfully setups up a vendor account (following the process ending at block 324), the user is provided with options that the user can select. The options include setting up account(s) for a different vendor (block 332; following marker “F” in FIG. 3A), managing one or more credit cards (block 333; following marker “G” in FIG. 3A), deleting one or more accounts on selected vendor websites from the card/payment management service (block 362; following marker “H” to FIG. 3H), or logging out of the account for the card/payment management service (block 368; following marker “I” to FIG. 3H).

If, at block 331, the user selects the option to set up account(s) for a different vendor (block 332; following marker “F” in FIG. 3A), the process returns to block 304 (following marker “A” back to FIG. 3B), and the process at blocks 304-332 repeats.

If, at block 331, the user selects the option to manage one or more credit cards (block 333; following marker “G” in FIG. 3A), the user is provided with additional options that the user can select. The additional options include adding a credit card to selected accounts of selected vendors (block 334; following marker “J” to FIG. 3D), updating information for a credit card for selected accounts of selected vendors (block 341; following marker “K” to FIG. 3E), deleting a credit card from selected accounts of selected vendors (block 348; following marker “L” to FIG. 3F), or updating billing information for selected accounts of selected vendors (block 355; following marker “M” to FIG. 3G).

If, at block 333, the user selects the option to add a credit card to selected accounts of selected vendors (block 334; following marker “J” to FIG. 3D), the process proceeds to block 335, at which the remote computer system(s) might store the new credit card information in the database. At block 336, the database might store the new credit card information in relation to the selected account(s) and/or selected vendor(s). The remote computer system(s) might, at block 337, push the new credit card information to all selected accounts of all selected vendors, resulting in the credit card information being added for selected accounts for each selected vendor (block 338). At block 339, the vendor website or server might notify the user of the addition of the credit card. The user might receive the notification that credit card has been added (block 340), and the process may return to one of block 331 (following marker “D” to FIG. 3A) or block 333 (following marker “N” to FIG. 3A).

If, at block 333, the user selects the option to update information for a credit card for selected accounts of selected vendors (block 341; following marker “K” to FIG. 3E), the process proceeds to block 342, at which the remote computer system(s) might store the updated credit card information in the database. At block 343, the database might store the updated credit card information in relation to the selected account(s) and/or selected vendor(s). The remote computer system(s) might, at block 344, push the updated credit card information to all selected accounts of all selected vendors, resulting in the credit card information being updated for selected accounts for each selected vendor (block 345). At block 346, the vendor website or server might notify the user of the update of the credit card information. The user might receive the notification that credit card information has been updated (block 347), and the process may return to one of block 331 (following marker “D” to FIG. 3A) or block 333 (following marker “N” to FIG. 3A).

If, at block 333, the user selects the option to delete a credit card from selected accounts of selected vendors (block 348; following marker “L” to FIG. 3F), the process proceeds to block 349, at which the remote computer system(s) might delete credit card information from the database. At block 350, the database might delete credit card information in relation to the selected account(s) and/or selected vendor(s). The remote computer system(s) might, at block 351, push the deletion of credit card information to all selected accounts of all selected vendors, resulting in the credit card information being deleted from selected accounts for each selected vendor (block 352). At block 353, the vendor website or server might notify the user of the deletion of the credit card. The user might receive the notification that credit card has been deleted (block 354), and the process may return to one of block 331 (following marker “D” to FIG. 3A) or block 333 (following marker “N” to FIG. 3A).

Although blocks 334-354 refer specifically to credit cards, the various embodiments are not so limited, and the processes in blocks 334-354 may be applicable to any form of payment, including, but not limited to, debit cards, checking accounts, savings accounts, loans (e.g., mortgage loans, credit loans, etc.), gift cards, loyalty cards, and/or the like.

If, at block 333, the user selects the option to update billing information for selected accounts of selected vendors (block 355; following marker “M” to FIG. 3G), the process proceeds to block 356, at which the remote computer system(s) might store the updated billing information in the database. At block 357, the database might store the updated billing information in relation to the selected account(s) and/or selected vendor(s). The remote computer system(s) might, at block 358, push the updated billing information to all selected accounts of all selected vendors, resulting in the billing information being updated for selected accounts for each selected vendor (block 359). At block 360, the vendor website or server might notify the user of the update of the billing information. The user might receive the notification that billing information has been updated (block 361), and the process may return to one of block 331 (following marker “D” to FIG. 3A) or block 333 (following marker “N” to FIG. 3A).

If, at block 331, the user selects the option to delete one or more accounts on selected vendor websites from the card/payment management service (block 362; following marker “H” to FIG. 3H), the process proceeds to block 363, at which the remote computer system(s) receives a request from the user to delete one or more accounts on selected vendor websites of selected vendors. The remote computer system(s) might remove the one or more accounts for the selected vendor(s) (block 364), and the database might delete the one or more accounts and/or the associated/corresponding user credentials for the one or more accounts in association with the vendor information (and/or in association with the user's account with the card/payment management service provider) (block 365). At block 366, the remote computer system(s) might notify the user that the one or more accounts have been deleted, and the notification might be received by the user at block 367. The process might then return to block 331 (following marker “D” to FIG. 3A).

If, at block 331, the user selects the option to log out of the account for the card/payment management service (block 368; following marker “I” to FIG. 3H), the process proceeds to block 369, which causes the remote computer system(s) to log the user out of the account.

Turning to FIG. 4, method 400 in FIG. 4A continues onto FIG. 4B, linked by the circular marker denoted by “A,” continues from FIG. 4B onto FIG. 4C linked by the circular markers denoted by “B” and “C.” Method 400 in FIG. 4C returns back to FIG. 4A linked by the circular marker denoted “D,” returns back to FIG. 4B linked by the circular marker denoted “E,” or returns to FIG. 4B linked by the circular marker denoted “A.” Method 400 in FIG. 4A also continues onto FIGS. 4C, 4D, 4H, and 4H linked by the circular markers denoted “F,” “G,” “H,” and “I,” respectively. Method 400 in FIG. 4H returns back to FIG. 4A linked by the circular marker denoted “D.” Method 400 in FIG. 4D continues onto FIGS. 4E, 4F, and 4G linked by the circular markers denoted “K,” “L,” and “M,” respectively. Method 400 in FIGS. 4D, 4E, 4F, and 4G return back to FIG. 4A linked by the circular marker denoted “D” or back to FIG. 4D linked by the circular marker denoted “N.”

Turning to FIG. 4A, Method 400 might comprise logging into a user account of a financial institution (block 401). In some cases, the financial institution might utilize a card/payment management system of a card/payment management service provider, which might be external to the financial institution. In some cases, separate user accounts in the card/payment management system might be established for each user by the financial institution. In some embodiments, the card/payment management service provider might be a “sub-contractor” of the financial institution for providing card/payment management services to the user. In some cases, the card/payment management service provider might license the service to the financial institution to provide the user with card/payment management services. According to some embodiments, the user might be made aware of the use of the services provided by card/payment management service provider, while in other cases, the user might be unaware of the use of the services provided by the card/payment management service provider and might instead believe (based on obscure information on the website of the financial institution or lack of information) that the financial institution is the entity providing the card/payment management service (which in some cases might be part of the agreement (i.e., license agreement) between the financial institution and the card/payment management service provider).

At block 402, method 400 might comprise the financial institution server(s) (e.g., server 155 shown in FIG. 1, which might be associated with the financial institution) providing the user with access to the user account (with the financial institution). At block 403, a determination may be made by the financial institution server(s) as to whether the user is enrolled in a card/payment management service. If so, the process proceeds to block 443 (following marker “D”). If not, the process proceeds to block 404.

Method 400, at block 404, might comprise the financial institution server(s) providing options for multi-vendor service enrollment, which, at block 405, might be received by the user. At block 406, the user might send a request to enroll in the multi-vendor service and might provide account information, and the request and account information might be received and relayed by the financial institution server(s) to a remote computer system(s) of a card/payment management service provider (block 407). The remote computer system(s) might receive the relayed request and account information (block 408), and might establish one or more accounts and notify the user (block 409). At block 410, a database associated with the remote computer system(s) (e.g., database 130 shown in FIG. 1) and/or a database associated with the financial institution server(s) (e.g., database 160 shown in FIG. 1) might store the account information. The financial institution server(s) might relay the notification to the user (block 411), which might be received by the user, at block 412. The process might then proceed to block 413 (following marker “A” to FIG. 4B).

With reference to FIG. 4B, method 400 might, at block 413, comprise the user providing instructions to set up one or more accounts on a vendor website for card/payment management service, through the financial institution (i.e., through a website of the financial institution that is hosted by the financial institution server(s)). In some cases, the financial institution server might communicatively couple with the card/payment management service provider (i.e., through a website of the card/payment management service provider that is hosted by the remote computer system(s)), in order to provide the user with the card/payment management service. The financial institution server(s), at block 414, might receive and relay the request to setup the vendor account(s). The remote computer system(s), at block 415, might receive the relayed request to setup the one or more vendor accounts, and, at block 416, might determine whether the vendor is listed on an existing list of vendors compiled by the card/payment management service provider. In some cases, such a determination might include querying a database (such as database 130 shown in FIG. 1).

The list of vendors represents that each listed vendor has an existing connection or relationship with the card/payment management service provider. In some cases, the vendor(s) might have provided the card/payment management service provider with an application programming interface (“API”) for ease of transfer of information between server(s) of the vendor(s) and the remote computer system(s) of the card/payment management service provider. Even when such a connection or relationship exists, some vendors may lack APIs, in which case, screen scraping techniques (including bi-directional screen scraping for obtaining and for entering information from/to data fields in the servers of these vendors) may be implemented. In some embodiments, without any formal relationship or contract between the vendor and the card/payment management service provider, a connection between the server of the vendor and the remote computer system(s) might include the remote computer system(s) accessing a website interface running on the server of the vendor.

If it is determined that the vendor is on the list, the process might proceed to block 421. However, if it is determined that the vendor is not on the list, the process might proceed to blocks 417 and 418, at which the remote computer system(s) and the vendor website might negotiate with each other to try to add the vendor on the list of vendors, by establishing a connection or relationship (either by contract, by accessing the vendor website or server, by downloading an API for the vendor website or server, and/or the like). Once a connection has been established, the remote computer system(s) might add the vendor to the list of vendors (block 419), which might be stored on the database (block 420).

Turning to block 421, the remote computer system(s) might request, of the user, the user's credentials for accessing the user's account(s) on the vendor website or server, which request might be relayed by the financial institution server(s) (block 422), and received by the user, at block 423. When the user provides the user's vendor credentials (block 424), and the financial institution server(s) relays the user's vendor credentials (block 425), the remote computer system(s) might relay the user's vendor credentials to the vendor website or server (block 426), which receives and validates the user's vendor credentials (block 427).

If the vendor website or server determines, at block 428, that the user credentials are valid, the process proceeds to block 429 (following marker “B” to FIG. 4C). At block 429, the vendor website or server might send a notification that the user credentials are valid, which, at block 430, might be received by the remote computer system(s). The remote computer system(s) might, at block 431, store the user credentials and notify the user, resulting in the user credentials being stored in association with the vendor information (and/or with the user's account with the card/payment management service provider) (block 432), the notification being relayed by the financial institution server(s) (block 433), and the user receiving a notification that the user account(s) has been set up for the vendor (block 434). The process then proceeds to block 443 in FIG. 4A (following marker “D”).

However, if the vendor website or server determines, at block 428, that the user credentials are invalid, the process proceeds to block 435 (following marker “C” to FIG. 4C). At block 435, the vendor website or server might send a notification that the user credentials are invalid, which, at block 436, might be received by the remote computer system(s). The remote computer system(s) might, at block 437, notify the user and might request the user provide correct user credentials. In some instances, the notification might be relayed by the financial institution server(s) (block 438). The user might receive the notification and request (block 439), and might provide (again), the user's vendor credentials (block 440), which might be relayed by the financial institution server(s) (block 441) and by the remote computer system(s) (block 442). The process then proceeds back to block 427 (following marker “E” back to FIG. 4B), and the process at blocks 428-434 or the process at blocks 428 and 335-342 may be repeated, as appropriate.

Although not shown in FIG. 4, if the number of times that the user enters invalid user credentials exceeds a predetermined number of tries (e.g., 3, 4, 5, or more times, etc.), the remote computer system(s) might notify the user of such and the process might automatically proceed to block 444 (following marker “F” in FIG. 4C). In some cases, the vendor website might, if the user entered a valid username (as part of the user credentials), notify the account holder (associated with the username, which may or may not be the user in FIG. 4) that the attempts have exceeded a threshold number of failed attempts to login and/or that the account has been locked for a predetermined period (e.g., 24 hours or more) and that the account holder should contact the vendor website administrator and/or wait until the predetermined period has passed before trying again.

At block 443, which may be reached if the user has previously enrolled in the card/payment management service or multi-vendor service (as determined at block 403) (and has already setup a vendor account through the service (not shown)), or if the user successfully enrolls in the service and successfully setups up a vendor account (following the process ending at block 434), the user is provided with options that the user can select. The options include setting up account(s) for a different vendor (block 444; following marker “F” to FIG. 4C), managing one or more credit cards (block 445; following marker “G” to FIG. 4D), deleting one or more accounts on selected vendor websites from the card/payment management service (block 478; following marker “H” to FIG. 4H), or logging out of the account for the card/payment management service (block 486; following marker “I” to FIG. 4H).

If, at block 443, the user selects the option to set up account(s) for a different vendor (block 444; following marker “F” to FIG. 4C), the process returns to block 413 (following marker “A” back to FIG. 4B), and the process at blocks 414-442 repeats.

If, at block 443, the user selects the option to manage one or more credit cards (block 445; following marker “G” to FIG. 4D), the user is provided with additional options that the user can select. The additional options include adding a credit card to selected accounts of selected vendors (block 446; following marker “J” to FIG. 4D), updating information for a credit card for selected accounts of selected vendors (block 454; following marker “K” to FIG. 4E), deleting a credit card from selected accounts of selected vendors (block 462; following marker “L” to FIG. 4F), or updating billing information for selected accounts of selected vendors (block 470; following marker “M” to FIG. 4G).

If, at block 445, the user selects the option to add a credit card to selected accounts of selected vendors (block 446; following marker “J” to FIG. 4D), the process proceeds to block 447, at which the financial institution server(s) might relay the information on the credit card, vendor(s), and/or account(s). At block 448, the remote computer system(s) might store the new credit card information in the database. At block 449, the database might store the new credit card information in relation to the selected account(s) and/or selected vendor(s). The remote computer system(s) might, at block 450, push the new credit card information to all selected accounts of all selected vendors, resulting in the credit card information being added for selected accounts for each selected vendor (block 451). At block 452, the vendor website or server might notify the user of the addition of the credit card. The user might receive the notification that credit card has been added (block 453), and the process may return to one of block 443 (following marker “D” to FIG. 4A) or block 445 (following marker “N” in FIG. 4D).

If, at block 445, the user selects the option to update information for a credit card for selected accounts of selected vendors (block 454; following marker “K” to FIG. 4E), the process proceeds to block 455, at which the financial institution server(s) might relay the information on the credit card, vendor(s), and/or account(s). At block 456, the remote computer system(s) might store the updated credit card information in the database. At block 457, the database might store the updated credit card information in relation to the selected account(s) and/or selected vendor(s). The remote computer system(s) might, at block 458, push the updated credit card information to all selected accounts of all selected vendors, resulting in the credit card information being updated for selected accounts for each selected vendor (block 459). At block 460, the vendor website or server might notify the user of the update of the credit card information. The user might receive the notification that credit card information has been updated (block 461), and the process may return to one of block 443 (following marker “D” to FIG. 4A) or block 445 (following marker “N” to FIG. 4D).

If, at block 445, the user selects the option to delete a credit card from selected accounts of selected vendors (block 462; following marker “L” to FIG. 4F), the process proceeds to block 463, at which the financial institution server(s) might relay the information on the credit card, vendor(s), and/or account(s). At block 464, the remote computer system(s) might delete credit card information from the database. At block 465, the database might delete credit card information in relation to the selected account(s) and/or selected vendor(s). The remote computer system(s) might, at block 466, push the deletion of credit card information to all selected accounts of all selected vendors, resulting in the credit card information being deleted from selected accounts for each selected vendor (block 467). At block 468, the vendor website or server might notify the user of the deletion of the credit card. The user might receive the notification that the credit card has been deleted (block 469), and the process may return to one of block 443 (following marker “D” to FIG. 4A) or block 445 (following marker “N” to FIG. 4D).

Although blocks 446-469 refer specifically to credit cards, the various embodiments are not so limited, and the processes in blocks 446-469 may be applicable to any form of payment, including, but not limited to, debit cards, checking accounts, savings accounts, loans (e.g., mortgage loans, credit loans, etc.), and/or the like.

If, at block 445, the user selects the option to update billing information for selected accounts of selected vendors (block 470; following marker “M” to FIG. 4G), the process proceeds to block 471, at which the financial institution server(s) might relay the information on billing, vendor(s), and/or account(s). At block 472, the remote computer system(s) might store the updated billing information in the database. At block 473, the database might store the updated billing information in relation to the selected account(s) and/or selected vendor(s). The remote computer system(s) might, at block 474, push the updated billing information to all selected accounts of all selected vendors, resulting in the billing information being updated for selected accounts for each selected vendor (block 475). At block 476, the vendor website or server might notify the user of the update of the billing information. The user might receive the notification that billing information has been updated (block 477), and the process may return to one of block 443 (following marker “D” to FIG. 4A) or block 445 (following marker “N” to FIG. 4D).

If, at block 443, the user selects the option to delete one or more accounts on selected vendor websites from the card/payment management service (block 478; following marker “H” to FIG. 4H), the process proceeds to block 479, at which the financial institution server(s) relays the request to the remote computer system(s). At block 480, the remote computer system(s) receives the relayed request from the user to delete one or more accounts on selected vendor websites of selected vendors. The remote computer system(s) might remove the one or more accounts for the selected vendor(s) (block 481), and the database might delete the one or more accounts and/or the associated/corresponding user credentials for the one or more accounts in association with the vendor information (and/or in association with the user's account with the card/payment management service provider) (block 482). At block 483, the remote computer system(s) might notify the user that the one or more accounts have been deleted, the notification might be relayed by the financial institution server(s) (block 484), and the notification might be received by the user at block 485. The process might then return to block 443 (following marker “D” to FIG. 4A).

If, at block 443, the user selects the option to log out of the account for the card/payment management service (block 486; following marker “I” to FIG. 4H), the process proceeds to block 487, which causes the remote computer system(s) to log the user out of the account.

Although the embodiment of FIG. 4 is described with respect to a financial institution or financial institution's server(s) acting as an intermediary between the user and the remote computer system(s), the various embodiments are not so limited, and the intermediary may be a non-financial institution or entity (or server(s) thereof). The non-financial institution or entity might include, without limitation, a merchant, a platform entity (including, without limitation, a search engine provider, a browser provider, etc.), a credit card processor (e.g., Visa®, Mastercard®, Discover®, American Express®, etc.), and/or the like.

FIGS. 5A-5C (collectively, “FIG. 5”) are general schematic flow diagrams illustrating another method 500 for implementing automatic updating or pushing of payment information (which, herein, includes, without limitation, credit card data, other payment information, account information, billing information, and/or the like) to multiple retail and payment sites, in accordance with various embodiments. With reference to FIG. 5A, method 500 might comprise, at block 505, providing a user interface to a user device associated with a user via an account management application running on the user device, the user interface enabling the user to manage a plurality of user accounts with vendors, with the plurality of user accounts being associated with the user. In some embodiments, the user device might include, but is not limited to, a gaming console, a DVR, a STB, one or more TVs, a desktop computer, a laptop computer, a tablet computer, a smart phone, a mobile phone, a portable gaming device, and/or the like, and the account management application might be a software application (“app”) that can be downloaded and/or installed on such user device.

Method 500 might further comprise receiving, with the user interface of the account management application and from the user, a first set of inputs comprising instructions to push payment information associated with the user (block 510), and receiving, with the user interface of the account management application and from the user, a second set of inputs comprising instructions indicating two or more user accounts for at least two vendor websites of a plurality of vendor websites with which the payment information is to be updated, each user account being associated with the user and with one vendor website of the plurality of vendor websites (block 515). In some embodiments, the account management application might relay the received first set of inputs and/or the received second set of inputs to a computer other than the user device. In some cases, such a computer might be a server computer in a network, which might include, without limitation, at least one of a server computer is associated with a web-based service provider, a server computer is associated with a financial institution, a server computer is associated with a credit card company, a server computer is associated with a non-financial institution, and/or the like.

At block 520, method 500 might comprise automatically concurrently pushing, with the account management application and over one or more networks in communication with at least each of the at least two vendor websites, the payment information to the two or more user accounts, in response to receiving the first and second sets of inputs from the user, each of the two or more user accounts being associated with the two or more vendor websites. Various embodiments of automatically concurrently pushing the payment information to the two or more user accounts is shown in, and described in detail with respect to, FIG. 5B.

According to some embodiments, the payment information might include, without limitation, account information, credit card information, debit card information, banking information, billing information, and/or the like. In some cases, the account information might comprise, for each relevant account (including, but not limited to, card/payment management service account, financial institution account, vendor account for each vendor, and/or the like) username of the user, password of the user, and/or the like. The credit card information might include, but is not limited to, type of credit card (e.g., Visa® credit card, Mastercard® credit card, American Express® credit card, Discover® card, and/or the like), credit card number, card security code, expiration date of the card, name of cardholder, and/or the like. Similarly, the debit card information might include, without limitation, type of debit card (e.g., Visa® debit card, Mastercard® debit card, and/or the like), credit card number, card security code, expiration date of the card, name of cardholder, and/or the like. Banking information might include, without limitation, name of bank, address of a bank branch, routing number for the bank, bank account number of the user, and/or the like. In some cases, banking information might include information of any type of financial institution (not limited to banks), including, but not limited to, credit unions, credit card companies, trust companies, and/or the like. Billing information might include, but is not limited to, name of the user, billing address of the user, mailing address of the user, telephone number(s) of the user, e-mail address(es) of the user, and/or the like. In some embodiments, two or more of the account information, the credit card information, the debit card information, the banking information, and/or the billing information might include overlapping information and/or overlapping types of information. In some cases, the overlapping information (and/or overlapping types of information) might include at least some of the same information (and/or at least some of the same types of information).

Method 500 might further comprise, at block 525, storing, on one or more data stores or data storage devices (located either local with the user device, local with computer, or remote from both the user device and the computer; e.g., one of database 130, 145, 160, or another database not shown in FIG. 1), one or more of at least a portion of the payment information associated with the user or at least a portion of information associated with the two or more user accounts.

Turning to FIG. 5B, automatically concurrently pushing the payment information to the two or more user accounts (at block 520) might, in some embodiments, comprise determining, with the account management application, processes by which each of the at least two vendor websites updates payment information (block 530) and automatically concurrently pushing the payment information to the two or more user accounts associated with the at least two of the plurality of vendor websites, based at least in part on the determined processes by which each of the at least two vendor websites updates payment information (block 535).

Alternatively, in some instances, automatically concurrently pushing the payment information to the two or more user accounts (at block 520) might comprise automatically concurrently pushing the payment information to the two or more user accounts corresponding to the at least two vendor websites of the plurality of vendor websites, via application programming interfaces (“APIs”) associated with each of the corresponding at least two vendor websites (block 540). With reference to FIG. 5C, automatically concurrently pushing the payment information to the two or more user accounts corresponding to the at least two vendor websites of the plurality of vendor websites, via application programming interfaces (“APIs”) associated with each of the corresponding at least two vendor websites (at block 540) might comprise determining, with the account management application, an application programming interface for each of the at least two vendor websites (block 550) and automatically concurrently pushing the payment information to each of the two or more user accounts associated with the at least two of the plurality of vendor websites, via the determined application programming interface for each of the at least two vendor websites (block 555).

Turning back to FIG. 5B, in some cases, at least one of the plurality of vendor websites might operate without application programming interfaces, and automatically concurrently pushing the payment information to the two or more user accounts (at block 520) might comprise automatically concurrently pushing the payment information to the two or more user accounts associated with the at least two vendor websites of the plurality of vendor websites, by entering the payment information using screen scraping (block 545). Here, as mentioned above, “screen scraping” might refer to unidirectional screen scraping to pull data from the vendor website (e.g., from a form or from a webpage of the vendor website), unidirectional screen scraping to enter data into the vendor website (e.g., into a form or into a webpage of the vendor website), or bi-directional screen scraping (i.e., both screen scraping to pull data from the vendor website (e.g., from a form or from a webpage of the vendor website) and screen scraping to enter data into the vendor website (e.g., into a form or into a webpage of the vendor website)). With reference to FIG. 5C, automatically concurrently pushing the payment information to the two or more user accounts associated with the at least two vendor websites of the plurality of vendor websites, by entering the payment information using screen scraping (at block 545) might comprise determining, with the account management application, portions of each of the at least two vendor websites corresponding to portions of the payment information being pushed (block 560) and automatically concurrently pushing the payment information to each of the two or more user accounts associated with the at least two of the plurality of vendor websites, by using screen scraping to enter the portions of the payment information into determined corresponding portions of each of the at least two vendor websites (block 565).

In some embodiments, at least one processor of the user device and/or at least one processor of a computer (which might include, without limitation, a server computer or other computing device) might be specifically configured to cause—via appropriate software, code, or other instructions that are stored on non-transitory computer readable medium in communication with the at least one processor, and that when executed by the at least one processor cause—the computer to provide the user interface to the user device associated with the user via the account management application running on the user device (at block 505); receive, with the user interface of the account management application and from the user, the first set of inputs comprising instructions to push payment information associated with the user (at block 510); receive, with the user interface of the account management application and from the user, the second set of inputs comprising instructions indicating two or more user accounts for at least two vendor websites of a plurality of vendor websites with which the payment information is to be updated (at block 515); automatically concurrently push, with the account management application and over the one or more networks in communication with the at least each of the at least two vendor websites, the payment information to the two or more user accounts, in response to receiving the first and second sets of inputs from the user (at block 520); store, on one or more data stores or data storage devices (located either local with the user device, local with computer, or remote from both the user device and the computer; e.g., one of database 130, 145, 160, or another database not shown in FIG. 1), the one or more of at least a portion of the payment information associated with the user or the at least a portion of information associated with the two or more user accounts (at block 525); and so on, as described above with respect to the processes of blocks 505 through 565 of FIGS. 5A-5C. Accordingly, the at least one processor, the user device, and/or the computer thereby become a specialized processor(s), user device, and/or computer performing specialized functionalities, and not merely a generic processor, computer, or computer component performing generic computer functions.

Notwithstanding this point, the ordered combination of the processes in at least 505-520 (and, in some cases, the combination of the processes at blocks 505-520 and the processes at one or more of blocks 525 through 565 of FIGS. 5A-5C) as a whole address the Internet-centric challenge of updating payment or account information associated with a user across multiple, oftentimes disparate on-line user account/vendor account systems associated with the multiple vendors. This is addressed by the automatic pushing or updating of the payment information (and/or account information) to the two or more user accounts that are associated with the two or more vendor web sites of the plurality of vendor websites, as described herein and as recited in the claims—the various different embodiments of the automatic pushing or updating being described in greater detail above with respect to blocks 520 and 530-545 of FIG. 5B and with respect to blocks 540-565 of FIG. 5C. These are meaningful limitations that add more than generally linking the use of any abstract idea to the Internet, because they solve an Internet-centric problem with a claimed solution that is necessarily rooted in computer technology, and thus amounts to significantly more than any such abstract idea.

Although the various embodiments of FIG. 5 above are directed to an “App-based” user interface, in some instances, the user interface running on the user device might be a non-App-based user interface.

Although not specifically shown in FIGS. 2-5, processes or steps shown in any figure may be reordered or omitted, as necessary or desired without deviating from the scope of the various embodiments. Similarly, one or more processes or steps shown in one of FIGS. 2-5, but not shown in another one of FIGS. 2-5, may be incorporated into the method of the other one of FIGS. 2-5 in any suitable or appropriate order with existing processes or steps in the other one of FIGS. 2-5 (consistent with the teachings herein), as necessary or desired without deviating from the scope of the various embodiments.

Exemplary System and Hardware Implementation

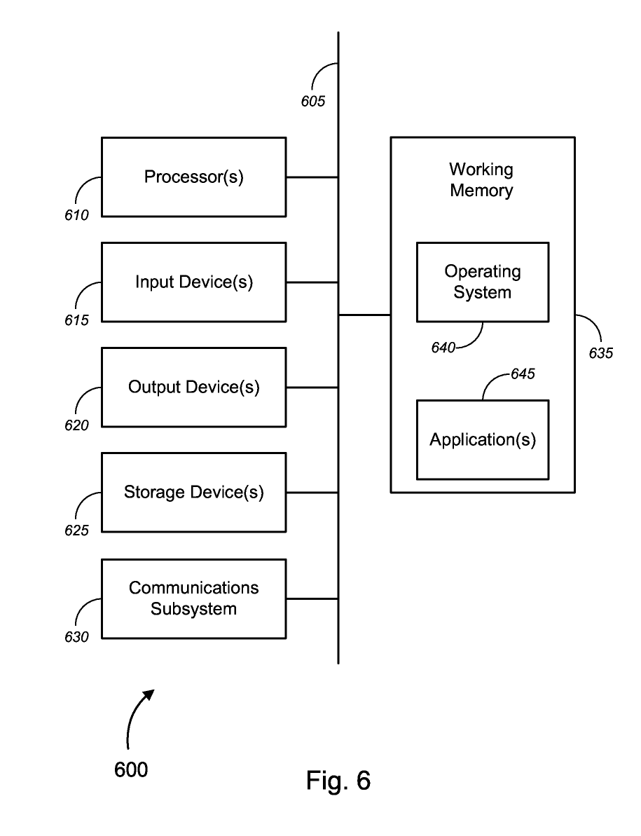

We now turn to FIG. 6, which is a block diagram illustrating an exemplary computer architecture. FIG. 6 provides a schematic illustration of one embodiment of a computer system 600 that can perform the methods provided by various other embodiments, as described herein, and/or can perform the functions of local computer system 105 or 110, or remote computer systems 115, 140, or 155, or other computer systems as described above. It should be noted that FIG. 6 is meant only to provide a generalized illustration of various components, of which one or more, or none, of each may be utilized as appropriate. FIG. 6, therefore, broadly illustrates how individual system elements may be implemented in a relatively separated or relatively more integrated manner.

The computer system 600 is shown comprising hardware elements that can be electrically coupled via a bus 605, or may otherwise be in communication, as appropriate. The hardware elements may include one or more processors 610, including without limitation one or more general-purpose processors, or one or more special-purpose processors such as digital signal processing chips, graphics acceleration processors, or the like; one or more input devices 615, which can include without limitation a mouse, a keyboard, or the like; and one or more output devices 620, which can include without limitation a display device, a printer, or the like.

The computer system 600 may further include, or be in communication with, one or more storage devices 625. The one or more storage devices 625 can comprise, without limitation, local and/or network accessible storage, or can include, without limitation, a disk drive, a drive array, an optical storage device, a solid-state storage device. The solid-state storage device can include, but is not limited to, one or more of a random access memory (“RAM”) or a read-only memory (“ROM”), which can be programmable, flash-updateable, or the like. Such storage devices may be configured to implement any appropriate data stores, including without limitation various file systems, database structures, or the like.

The computer system 600 might also include a communications subsystem 630, which can include without limitation a modem, a network card (wireless or wired), an infra-red communication device, a wireless communication device or chipset, or the like. The wireless communication device might include, but is not limited to, a Bluetooth™ device, an 802.11 device, a WiFi device, a WiMax device, a WWAN device, cellular communication facilities, or the like.

The communications subsystem 630 may permit data to be exchanged with a network (such as network 120 or 150, to name examples), with other computer systems, with any other devices described herein, or with any combination of network, systems, and devices. According to some embodiments, network 120 (as well as network 150) might include a local area network (“LAN”), including without limitation a fiber network, an Ethernet network, a Token-Ring™ network, and the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol, or any other wireless protocol; or any combination of these or other networks. In many embodiments, the computer system 600 will further comprise a working memory 635, which can include a RAM or ROM device, as described above.

The computer system 600 may also comprise software elements, shown as being currently located within the working memory 635, including an operating system 640, device drivers, executable libraries, or other code. The software elements may include one or more application programs 645, which may comprise computer programs provided by various embodiments, or may be designed to implement methods and/or configure systems provided by other embodiments, as described herein. Merely by way of example, one or more procedures described with respect to the methods discussed above might be implemented as code or instructions executable by a computer or by a processor within a computer. In an aspect, such code or instructions can be used to configure or adapt a general purpose computer, or other device, to perform one or more operations in accordance with the described methods.

A set of these instructions or code might be encoded and/or stored on a non-transitory computer readable storage medium, such as the storage devices 625 described above. In some cases, the storage medium might be incorporated within a computer system, such as the system 600. In other embodiments, the storage medium might be separate from a computer system—that is, a removable medium, such as a compact disc, or the like. In some embodiments, the storage medium might be provided in an installation package, such that the storage medium can be used to program, configure, and/or adapt a general purpose computer with the instructions/code stored thereon. These instructions might take the form of executable code, which is executable by the computer system 600, or might take the form of source or installable code. The source or installable code, upon compilation, installation, or both compilation and installation, on the computer system 600 might take the form of executable code. Compilation or installation might be performed using any of a variety of generally available compilers, installation programs, compression/decompression utilities, or the like.

It will be apparent to those skilled in the art that substantial variations may be made in accordance with specific requirements. For example, customized hardware—such as programmable logic controllers, field-programmable gate arrays, application-specific integrated circuits, or the like—might also be used. In some cases, particular elements might be implemented in hardware, software (including portable software, such as applets, etc.), or both. Further, connection to other computing devices such as network input/output devices may be employed.

As mentioned above, in one aspect, some embodiments may employ a computer system, such as the computer system 600, to perform methods in accordance with various embodiments of the invention. According to a set of embodiments, some or all of the procedures of such methods might be performed by the computer system 600 in response to processor 610 executing one or more sequences of one or more instructions. The one or more instructions might be incorporated into the operating system 640 or other code that may be contained in the working memory 635, such as an application program 645. Such instructions may be read into the working memory 635 from another computer readable medium, such as one or more of the storage devices 625. Merely by way of example, execution of the sequences of instructions contained in the working memory 635 might cause the one or more processors 610 to perform one or more procedures of the methods described herein.

The terms “machine readable medium” and “computer readable medium,” as used herein, refer to any medium that participates in providing data that causes a machine to operate in a specific fashion. In an embodiment implemented using the computer system 600, various computer readable media might be involved in providing instructions or code to the one or more processors 610 for execution, might be used to store and/or carry such instructions/code such as signals, or both. In many implementations, a computer readable medium is a non-transitory, physical, or tangible storage medium. Such a medium may take many forms, including, but not limited to, non-volatile media, volatile media, or the like. Non-volatile media includes, for example, optical disks, magnetic disks, or both, such as the storage devices 625. Volatile media includes, without limitation, dynamic memory, such as the working memory 635. In some alternative embodiments, a computer readable medium may take the form of transmission media, which includes, without limitation, coaxial cables, copper wire and fiber optics, including the wires that comprise the bus 605, as well as the various components of the communication subsystem 630 (and/or the media by which the communications subsystem 630 provides communication with other devices). In an alternative set of embodiments, transmission media can also take the form of waves (including without limitation radio, acoustic and/or light waves, such as those generated during radio-wave and infra-red data communications).

Common forms of physical or tangible computer readable media include, for example, a floppy disk, a flexible disk, a hard disk, magnetic tape, or any other magnetic medium; a CD-ROM, DVD-ROM, or any other optical medium; punch cards, paper tape, or any other physical medium with patterns of holes; a RAM, a PROM, an EPROM, a FLASH-EPROM, or any other memory chip or cartridge; a carrier wave; or any other medium from which a computer can read instructions or code.

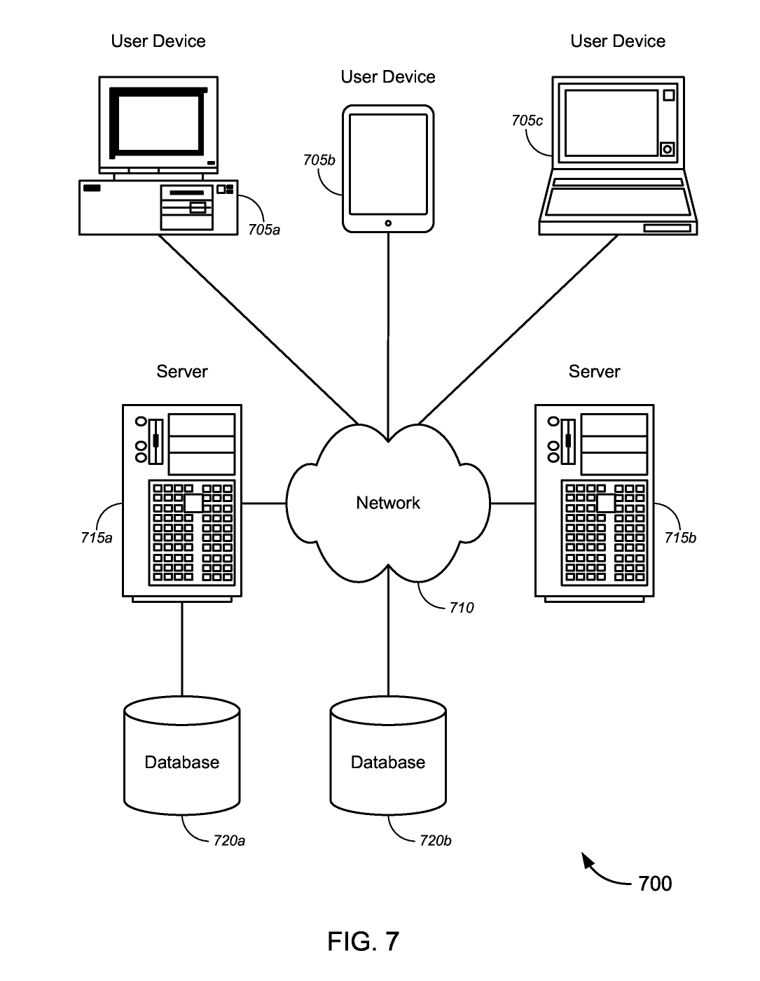

As noted above, a set of embodiments comprises methods and systems for implementing automatic updating or pushing of payment information (which, herein, includes, without limitation, credit card data, other payment information, account information, billing information, and/or the like) to multiple retail and payment sites. FIG. 7 illustrates a schematic diagram of a system 700 that can be used in accordance with one set of embodiments. The system 700 can include two or more user computers or user devices 705. A user computer or user device 705 can be a general purpose personal computer (including, merely by way of example, desktop computers, tablet computers, laptop computers, handheld computers, and the like, running any appropriate operating system, several of which are available from vendors such as Apple, Microsoft Corp., and the like) and/or a workstation computer running any of a variety of commercially-available UNIX™ or UNIX-like operating systems. A user computer or user device 705 can also have any of a variety of applications, including one or more applications configured to perform methods provided by various embodiments (as described above, for example), as well as one or more office applications, database client and/or server applications, and/or web browser applications. Alternatively, a user computer or user device 705 can be any other electronic device, such as a thin-client computer, Internet-enabled mobile telephone, and/or personal digital assistant, capable of communicating via a network (e.g., the network 710 described below) and/or of displaying and navigating web pages or other types of electronic documents. Although the exemplary system 700 is shown with three user computers or user devices 705, any number of user computers or user devices can be supported.

Certain embodiments operate in a networked environment, which can include a network 710. The network 710 can be any type of network familiar to those skilled in the art that can support data communications using any of a variety of commercially-available (and/or free or proprietary) protocols, including without limitation TCP/IP, SNA™, IPX™, AppleTalk™, and the like. Merely by way of example, the network 710 can include a local area network (“LAN”), including without limitation a fiber network, an Ethernet network, a Token-Ring™ network and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks. In a particular embodiment, the network might include an access network of the service provider (e.g., an Internet service provider (“ISP”)). In another embodiment, the network might include a core network of the service provider, and/or the Internet.

Embodiments can also include one or more server computers 715. Each of the server computers 715 may be configured with an operating system, including without limitation any of those discussed above, as well as any commercially (or freely) available server operating systems. Each of the servers 715 may also be running one or more applications, which can be configured to provide services to one or more clients 705 and/or other servers 715.

Merely by way of example, one of the servers 715 might be a data server, as described above. The data server might include (or be in communication with) a web server, which can be used, merely by way of example, to process requests for web pages or other electronic documents from user computers 705. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 705 to perform methods of the invention.

The server computers 715, in some embodiments, might include one or more application servers, which can be configured with one or more applications accessible by a client running on one or more of the client computers 705 and/or other servers 715. Merely by way of example, the server(s) 715 can be one or more general purpose computers capable of executing programs or scripts in response to the user computers 705 and/or other servers 715, including without limitation web applications (which might, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, Selenium, or TCL, as well as combinations of any programming and/or scripting languages. The application server(s) can also include database servers, including without limitation those commercially available from Oracle™, Microsoft™, Sybase™′ IBM™ and the like, which can process requests from clients (including, depending on the configuration, dedicated database clients, API clients, web browsers, etc.) running on a user computer or user device 705 and/or another server 715. In some embodiments, an application server can perform one or more of the processes for implementing automatic pushing or updating of payment information associated with users to multiple vendor websites, or the like, as described in detail above. Data provided by an application server may be formatted as one or more web pages (comprising HTML, JavaScript, etc., for example) and/or may be forwarded to a user computer 705 via a web server (as described above, for example). Similarly, a web server might receive web page requests and/or input data from a user computer 705 and/or forward the web page requests and/or input data to an application server. In some cases a web server may be integrated with an application server.

In accordance with further embodiments, one or more servers 715 can function as a file server and/or can include one or more of the files (e.g., application code, data files, etc.) necessary to implement various disclosed methods, incorporated by an application running on a user computer 705 and/or another server 715. Alternatively, as those skilled in the art will appreciate, a file server can include all necessary files, allowing such an application to be invoked remotely by a user computer or user device 705 and/or server 715.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 720. The location of the database(s) 720 is discretionary: merely by way of example, a database 720a might reside on a storage medium local to (and/or resident in) a server 715a (and/or a user computer or user device 705). Alternatively, a database 720b can be remote from any or all of the computers 705, 715, so long as it can be in communication (e.g., via the network 710) with one or more of these. In a particular set of embodiments, a database 720 can reside in a storage-area network (“SAN”) familiar to those skilled in the art. (Likewise, any necessary files for performing the functions attributed to the computers 705, 715 can be stored locally on the respective computer and/or remotely, as appropriate.) In one set of embodiments, the database 720 can be a relational database, such as an Oracle database, that is adapted to store, update, and retrieve data in response to SQL-formatted commands. The database might be controlled and/or maintained by a database server, as described above, for example.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method for implementing automatic updating of payment information associated with users to multiple vendor websites, comprising:
providing a user interface to a user device associated with a user via an account management application running on the user device, the user interface enabling the user to manage a plurality of user accounts with vendors, the plurality of user accounts being associated with the user;
receiving, with the user interface of the account management application, a first set of inputs from the user, the first set of inputs comprising instructions to push payment information associated with the user;
receiving, with the user interface of the account management application, a second set of inputs from the user, the second set of inputs comprising instructions indicating two or more user accounts for at least two vendor websites of a plurality of vendor websites with which the payment information is to be updated, each user account being associated with the user and with one vendor website of the plurality of vendor websites;
automatically concurrently pushing, with the account management application and over one or more networks in communication with at least each of the at least two vendor websites, the payment information to the two or more user accounts, in response to receiving the first and second sets of inputs from the user, each of the two or more user accounts being associated with the two or more vendor websites.

2. The method of claim 1, wherein the payment information associated with the user comprises at least one of credit card information, debit card information, or billing information associated with the user.

3. The method of claim 2, wherein the billing information associated with the user comprises at least one of name of the user, username of the user, password of the user, a billing address, one or more mailing addresses, one or more e-mail addresses, or one or more telephone numbers.

4. The method of claim 1, wherein automatically concurrently pushing the payment information to the two or more user accounts comprises automatically concurrently pushing, with the account management application via a server computer in the one or more networks and over one or more networks in communication at least with the server computer and with each of the at least two vendor websites, the payment information to the two or more user accounts, in response to receiving the first and second sets of inputs from the user, each user account being associated with the two or more vendor websites.

5. The method of claim 4, wherein the server computer is associated with a web-based service provider.

6. The method of claim 4, wherein the server computer is associated with a financial institution.

7. The method of claim 6, wherein the payment information associated with the user comprises credit card information of a credit card associated with the user, and wherein the credit card associated with the user is at least one of associated with the financial institution or issued by the financial institution.

8. The method of claim 4, wherein the server computer is associated with a credit card company.

9. The method of claim 4, wherein the server computer is associated with a non-financial institution.

10. The method of claim 1, wherein at least one of the two or more user accounts is an existing account on a corresponding one vendor website of the plurality of vendor websites.

11. The method of claim 10, wherein automatically concurrently pushing the payment information comprises updating the payment information on the existing account on the corresponding one vendor website.

12. The method of claim 1, wherein at least one of the two or more user accounts is a new account on a corresponding one vendor website of the plurality of vendor websites.

13. The method of claim 12, wherein automatically concurrently pushing the payment information comprises:
establishing, with the computer, a new account associated with the user on one or more vendor websites; and
pushing, with the computer, the payment information to the newly established account on each of the one or more vendor websites.

14. The method of claim 1, wherein the plurality of vendor websites comprises at least one of one or more retail websites, one or more service websites, one or more subscription websites, or one or more payment service websites.

15. The method of claim 14, wherein the one or more retail websites comprise websites associated with product retailers, wherein the one or more service websites comprise websites associated with service providers, comprising at least one of utility service providers, on-line service providers, or other service providers, wherein the one or more subscription websites comprise websites associated with companies that provide one or more of products or services that require a paid subscription for access by the user, wherein the one or more payment service websites comprise websites associated with services that facilitate payment on other websites to purchase at least one of services or products.

16. The method of claim 15, wherein the one or more payment service websites comprise one or more billpay service websites that facilitate recurring payment of bills for one or more of services or products purchased by the user.

17. The method of claim 1, further comprising:
receiving, with the user interface of the account management application, a third set of inputs from the user, the third set of inputs comprising instructions for managing a plurality of credit cards associated with the user.

18. The method of claim 17, wherein instructions for managing the plurality of credit cards associated with the user comprises at least one of instructions for adding one or more new credit cards, instructions for deleting one or more existing credit cards, or instructions for updating information for one or more existing credit cards.

19. The method of claim 1, further comprising:
receiving, with the user interface of the account management application, a fourth set of inputs from the user, the fourth set of inputs comprising instructions for managing one or more accounts associated with the user on one or more vendor websites associated with one or more vendors of a plurality of vendors.

20. The method of claim 1, automatically concurrently pushing the payment information comprises automatically concurrently pushing the payment information to the two or more user accounts corresponding to the at least two vendor web sites of the plurality of vendor websites, via application programming interfaces associated with each of the corresponding at least two vendor websites.

21. The method of claim 1, automatically concurrently pushing the payment information to the two or more user accounts corresponding to the at least two vendor websites of the plurality of vendor websites, via application programming interfaces associated with each of the corresponding at least two vendor websites, comprises:
determining, with the account management application, an application programming interface for each of the at least two vendor websites; and
automatically concurrently pushing the payment information to each of the two or more user accounts associated with the at least two of the plurality of vendor websites, via the determined application programming interface for each of the at least two vendor websites.

22. The method of claim 1, wherein at least one of the plurality of vendor websites operates without application programming interfaces, wherein automatically concurrently pushing the payment information comprises automatically concurrently pushing the payment information to the two or more user accounts associated with the at least two vendor websites of the plurality of vendor websites, by entering the payment information using screen scraping.

23. The method of claim 1, wherein automatically concurrently pushing the payment information to the two or more user accounts associated with the at least two vendor websites of the plurality of vendor websites, by entering the payment information using screen scraping, comprises:
determining, with the account management application, portions of each of the at least two vendor websites corresponding to portions of the payment information being pushed; and
automatically concurrently pushing the payment information to each of the two or more user accounts associated with the at least two of the plurality of vendor websites, by using screen scraping to enter the portions of the payment information into determined corresponding portions of each of the at least two vendor websites.

24. The method of claim 1, wherein automatically concurrently pushing the payment information comprises:
determining, with the account management application, processes by which each of the at least two vendor websites updates payment information; and
automatically concurrently pushing the payment information to the two or more user accounts associated with the at least two of the plurality of vendor websites, based at least in part on the determined processes by which each of the at least two vendor websites updates payment information.

25. The method of claim 1, further comprising:
storing, on one or more data stores, one or more of at least a portion of the payment information associated with the user or at least a portion of information associated with the two or more user accounts.

26. An apparatus for implementing automatic updating of payment information associated with users to multiple vendor websites, comprising:
a non-transitory computer readable medium in communication with at least one processor, the computer readable storage medium having stored thereon computer software, the computer software comprising a set of instructions that, when executed by the at least one processor, causes the apparatus to:
provide a user interface to a user device associated with a user via an account management application running on the user device, the user interface enabling the user to manage a plurality of user accounts with vendors, the plurality of user accounts being associated with the user;
receive, with the user interface of the account management application, a first set of inputs from the user, the first set of inputs comprising instructions to push payment information associated with the user;
receive, with the user interface of the account management application, a second set of inputs from the user, the second set of inputs comprising instructions indicating two or more user accounts for at least two vendor websites of a plurality of vendor websites with which the payment information is to be updated, each user account being associated with the user and with one vendor website of the plurality of vendor websites; and
automatically concurrently push, with the account management application and over one or more networks in communication with at least each of the at least two vendor websites, the payment information to the two or more user accounts, in response to receiving the first and second sets of inputs from the user, the two or more user accounts being associated with the at least two vendor websites of the plurality of vendor websites.

27. A system for implementing automatic updating of payment information associated with users to multiple vendor websites, comprising:
a data storage device;
a computer in communication with the data storage device, the computer comprising:
at least one processor; and
a computer readable storage medium in communication with the at least one processor, the computer readable storage medium having stored thereon computer software, the computer software comprising a set of instructions that, when executed by the at least one processor, causes the computer to:
provide a user interface to a user device associated with a user via an account management application running on the user device, the user interface enabling the user to manage a plurality of user accounts with vendors, the plurality of user accounts being associated with the user;
receive, with the user interface of the account management application, a first set of inputs from the user, the first set of inputs comprising instructions to push payment information associated with the user;
store at least a portion of the payment information associated with the user on the data storage device;
receive, with the user interface of the account management application, a second set of inputs from the user, the second set of inputs comprising instructions indicating two or more user accounts for at least two vendor websites of a plurality of vendor websites with which the payment information is to be updated, each user account being associated with the user and with one vendor website of the plurality of vendor websites;
store at least a portion of information associated with the two or more user accounts on the data storage device; and
automatically concurrently push, with the account management application and over one or more networks in communication with at least each of the at least two vendor websites, the payment information to the two or more user accounts, in response to receiving the first and second sets of inputs from the user, the two or more user accounts being associated with the at least two vendor websites of the plurality of vendor websites.

28. A method for implementing automatic updating of payment information associated with users to multiple vendor websites, comprising:
automatically concurrently pushing, with a computer, at least one of credit card information or billing information associated with a user to a plurality of user accounts of a plurality of vendor websites, the user accounts being associated with the user, in response to receiving input from the user.
